(19) United States
(12) Patent Application Publication
(10) Pub. No.: US 2018/0160198 A1
(43) Pub. Date: Jun. 7, 2018

(54) GENERATION DEVICE

(71) Applicant: SHARP KABUSHIKI KAISHA, Sakai City, Osaka (JP)

(72) Inventors: SHUHICHI WATANABE, Sakai City (JP); TAKUYA IWANAMI, Sakai City (JP); CHANBIN NI, Sakai City (JP)

(21) Appl. No.: 15/736,504

(22) PCT Filed: May 18, 2016
(86) PCT No.: PCT/JP2016/064789

§ 371 Date: Dec. 14, 2017

(30) Foreign Application Priority Data
Jun. 16, 2015 (JP) 2015-121552
Oct. 13, 2015 (JP) 2015-202303

(51) Int. Cl. H04N 21/84; G06F 17/30; H04N 5/76

(52) U.S. Cl. CPC H04N 21/84; H04N 5/76; G06F 17/30017

(57) ABSTRACT

New description information that can be used for the playback and management of video data is generated. A photographing device (1) is provided with: a target information acquisition unit (17) that acquires position information indicating the position of a predetermined object within a video; and a resource information generation unit (18) that generates resource information including the position information, as description information relating to data of the video.

### TECHNICAL FIELD

The present invention relates to a generation device of description information that can be used to play a video, a transmission device that transmits the description information, a playback device that plays a video using the description information, and the like.

### BACKGROUND ART

In recent years, photographing devices such as digital cameras, and smartphones and tablets equipped with photographing functions, for example, have become widespread. In particular, portable devices provided with photographing functions such as smartphones have rapidly become widespread. As a result, many users have also come to own a large quantity of media data, and the quantity of such media data that is stored on the Internet (cloud) is also becoming enormous.

Also, locator information acquired by GPS (Global Positioning System) and description information (metadata) indicating photographing times and the like acquired during photographing are used for the management of such media data. For example, description information for images is stipulated in EXIF (exchangeable image file format) described in NPL 1 hereinafter. This kind of description information is appended to media data, and media data can thereby be organized and managed on the basis of photographing positions and photographing times.

### CITATION LIST

### Non Patent Literature

NPL 1: “Exif Exchangeable Image File Format, Version 2.2”, [online], [retrieved Jun. 12, 2015], Internet <URL: http://www.digitalpreservation.gov/formats/fdd/fdd000146.sht ml>

### SUMMARY OF INVENTION

### Technical Problem

However, as mentioned above, recently, various videos captured by various users have come to be stored, and even extracting a desired video from among the enormous quantity of videos has become difficult with only description information indicating photographing positions and photographing times.

The present invention takes the aforementioned point into consideration, and an objective thereof is to provide a generation device or the like capable of generating new description information that can be used for the playback, management, and the like of video data.

### Solution to Problem

In order to solve the aforementioned problem, a generation device according to an aspect of the present invention is a generation device of description information relating to data of a video, provided with: a target information acquisition unit that acquires position information indicating a position of a predetermined object within the video; and a description information generation unit that generates description information including the position information, as the description information relating to the data of the video.

Furthermore, another generation device according to an aspect of the present invention, in order to solve the aforementioned problem, is a generation device of description information relating to data of a video, provided with: a target information acquisition unit that acquires position information indicating a position of a predetermined object within the video; a photographing information acquisition unit that acquires position information indicating a position of a photographing device that captured the video; and a description information generation unit that generates, as the description information relating to the data of the video, description information that includes information indicating which position information is included out of the position information acquired by the target information acquisition unit and the position information acquired by the photographing information acquisition unit, and also includes the position information indicated by the information.

Also, yet another generation device according to an aspect of the present invention, in order to solve the aforementioned problem, is a generation device of description information relating to data of a video image, provided with: an information acquisition unit that respectively acquires position information indicating a photographing position of the video image or a position of a predetermined object within the video image, at a plurality of different points in time from capturing of the video image starting to ending; and a description information generation unit that generates description information including the position information at the plurality of different points in time, as the description information relating to the data of the video image.

### Advantageous Effects of Invention

According to the aforementioned aspects of the present invention, an effect is demonstrated in that it is possible to generate new description information that can be used for the playback and management of video data.

### BRIEF DESCRIPTION OF DRAWINGS

FIG. 1 is a block diagram depicting an example of the main configuration of the devices included in a media-related information generation system according to embodiment 1 of the present invention.

FIG. 2 is a drawing describing an overview of the media-related information generation system.

FIG. 3 is a drawing depicting an example of media data being played using resource information.

FIG. 4 is a drawing depicting an example of a photographing device generating resource information, and an example of a photographing device and a server generating resource information.

FIG. 5 is a drawing depicting an example of description/control units of playback information.

FIG. 6 is a drawing depicting an example of syntax for resource information for a still image.

FIG. 7 is a drawing depicting an example of syntax for resource information for a video image.

FIG. 8 is a flowchart depicting an example of processing for generating resource information in a case where media data is a still image.

FIG. 9 is a flowchart depicting an example of processing for generating resource information in a case where media data is a video image.

FIG. 10 is a drawing depicting an example of syntax for environment information.

FIG. 11 is a drawing depicting an example of playback information stipulating a playback mode for two items of media data.

FIG. 12 is a drawing depicting another example of playback information stipulating a playback mode for two items of media data.

FIG. 13 is a drawing depicting an example of playback information that includes information regarding a time shift.

FIG. 14 is a drawing depicting an example of playback information in which playback-target media data is designated by position designation information.

FIG. 15 is a drawing describing an advantage of playing a video of a nearby position that does not strictly match a designated position.

FIG. 16 is a drawing depicting another example of playback information in which playback-target media data is designated by position designation information.

FIG. 17 is a drawing depicting an example of playback information in which playback-target media data is designated by a pair of items of position designation information and time designation information.

FIG. 18 is a drawing depicting another example of playback information in which playback-target media data is designated by a pair of items of position designation information and time designation information.

FIG. 19 is a drawing describing a portion of an overview of a media-related information generation system according to embodiment 2 of the present invention.

FIG. 20 is a drawing depicting an example of syntax for resource information for a still image.

FIG. 21 is a drawing depicting an example of syntax for resource information for a video image.

FIG. 22 is a drawing depicting an example of playback information stipulating a playback mode for media data.

FIG. 23 is a drawing depicting a field of view and center of vision of a photographing device.

FIG. 24 is a drawing depicting the field of view and center of vision of the photographing devices in FIG. 19.

FIG. 25 is a drawing depicting another example of playback information stipulating a playback mode for media data.

### DESCRIPTION OF EMBODIMENTS

### Embodiment 1

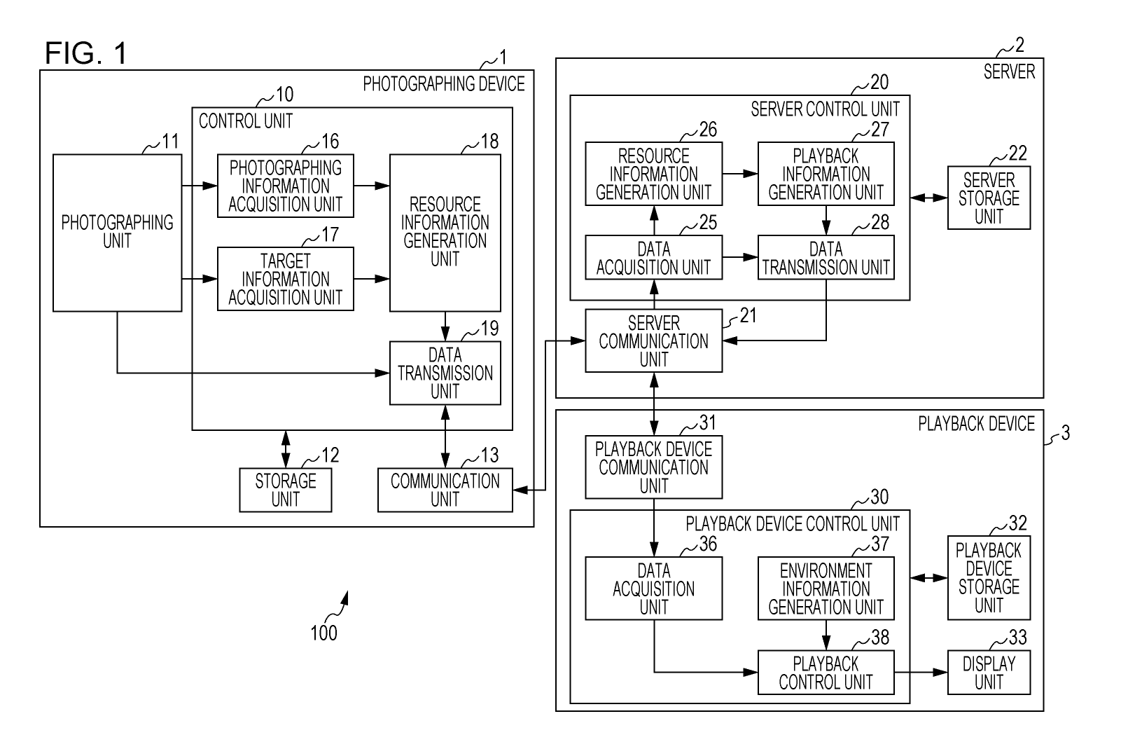

Hereinafter, embodiment 1 of the present invention will be described in detail on the basis of FIGS. 1 to 18.

### [Overview of System]

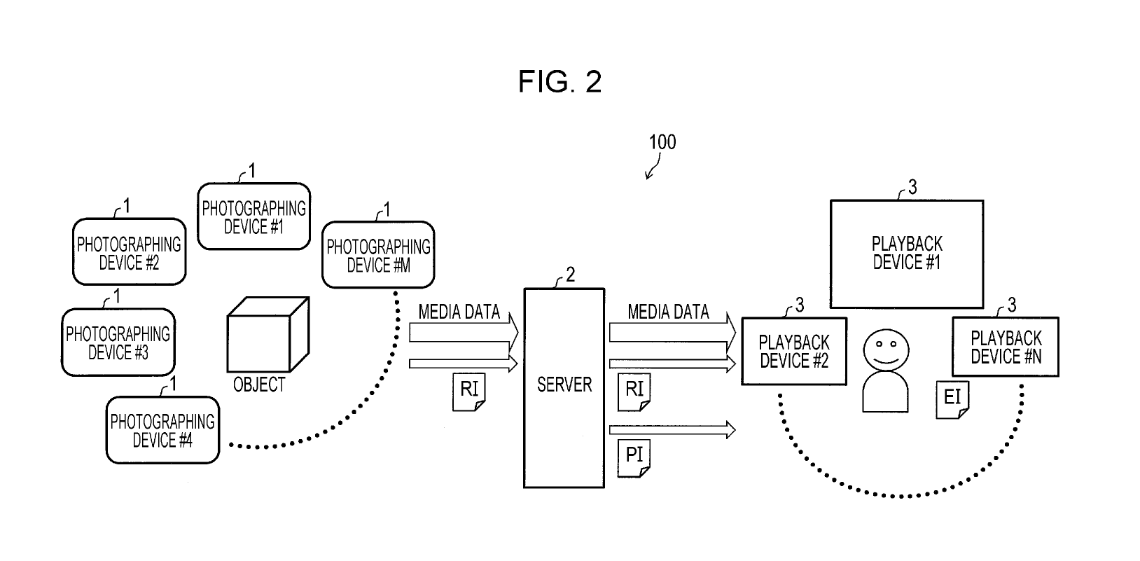

First, an overview of a media-related information generation system 100 according to the present embodiment will be described based on FIG. 2. FIG. 2 is a drawing describing an overview of the media-related information generation system 100. The media-related information generation system 100 is a system for generating description information (metadata) relating to the playback of media data such as video images and still images, for example, and includes a photographing device (a generation device) 1, a server (a generation device) 2, and a playback device 3, as depicted.

The photographing device 1 is provided with a function for capturing a video (video image or still image), and also a function for generating resource information (RI: resource information) that includes time information indicating a photographing time and position information indicating a photographing position or a position of a photographing-target object. In the depicted example, M number of #1 to #M photographing devices 1 are arranged in a circular form in such a way as to surround a photographing-target object; however, there may be at least one photographing device 1, and the arrangement (relative position with respect to the object) of the photographing device 1 is also arbitrary. The details are described later on; however, in a case where position information of an object is included in resource information, it becomes easy for media data relating to one object to be played in a synchronized manner.

The server 2 acquires media data (still image or video image) obtained by photographing and the aforementioned resource information from the photographing device 1, and transmits the media data and the resource information to the playback device 3. Furthermore, the server 2 is also provided with a function for newly generating resource information by analyzing the media data received from the photographing device 1, and, when having generated resource information, transmits the generated resource information to the playback device 3.

Furthermore, the server 2 is also provided with a function for generating playback information (PI: presentation information) using resource information acquired from the photographing device 1, and, when having generated playback information, also transmits the generated playback information to the playback device 3. The details are described later on; however, the playback information is information stipulating a playback mode for media data, and the playback device 3, by referring to this playback information, is able to play media data in a mode corresponding to the resource information. It should be noted that, although the present drawing depicts an example in which there is one server 2, the server 2 may be configured in a virtual manner by using a plurality of devices using cloud technology.

The playback device 3 is a device that plays media data acquired from the server 2. As mentioned above, the server 2 transmits resource information together with media data to the playback device 3, and the playback device 3 therefore plays the media data using the received resource information. Furthermore, in a case where playback information is received together with media data, it is also possible for the media data to be played using the playback information. Furthermore, the playback device 3 is also provided with a function for generating environment information (EI: environment information) indicating the position, direction, and the like of the playback device 3, and plays media data with reference to the environment information. It should be noted that the details of the environment information will be described later on.

In the depicted example, N number of #1 to #N playback devices 3 are arranged in a circular form in such a way as to surround the user viewing the media data; however, there may be at least one playback device 3, and the arrangement (relative position with respect to the user) of the playback device 3 is also arbitrary.

### [Example of Playback Based on Resource Information]

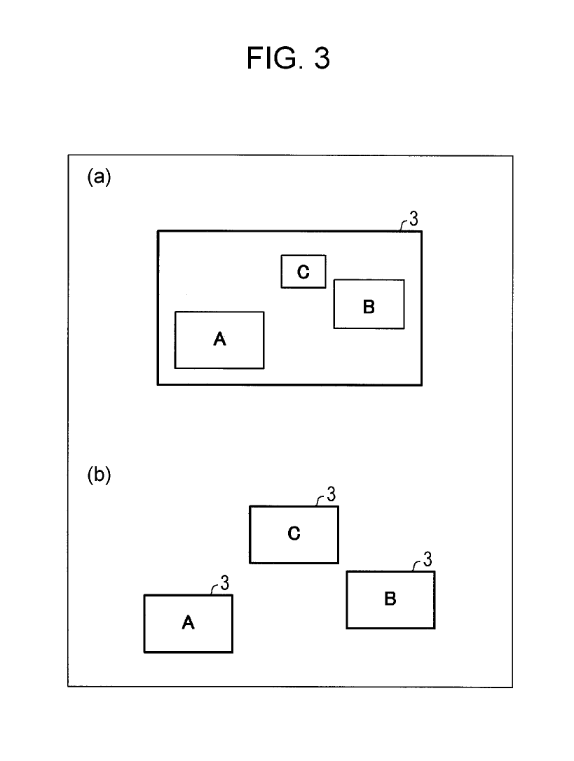

Next, an example of playback based on resource information will be described based on FIG. 3. FIG. 3 is a drawing depicting an example of media data being played using resource information. Resource information includes time information and position information, and therefore, by referring to resource information, media data that has been captured nearby in terms of time and position can be extracted from among a plurality of items of media data. Furthermore, by referring to resource information, the extracted media data can also be played with the time and position being synchronized.

For example, at an event at which many users participate at the same time such as a festival or a concert, each participant carries out photographing in his or her own way with a smartphone or the like. Media data obtained by this kind of photographing includes a variety of photographed objects and photographing times. However, in the prior art, resource information such as the aforementioned was not added to media data. Therefore, video analysis or the like was necessary to extract media data in which the same object has been captured, and the synchronized playback of media data in which the same object has been captured had a high threshold.

In contrast, in the media-related information generation system 100, resource information is added to each item of media data, and therefore media data having the same captured object can be easily extracted by referring to this resource information. For example, it is also easy to extract a video in which a specific person has been captured.

Furthermore, position information is included in the resource information, and it therefore also becomes possible to play media data in a mode that corresponds to the position indicated by the position information. For example, a case is assumed in which three items of media data A to C are to be played, the media data having been obtained by the same object being captured by respectively different photographing devices 1 at the same time. In this case, if there is one playback device 3 as in (a) of the same drawing, the display position of each item of media data can be made to be the photographing position of the media data in question, or a position that corresponds to the distance between the photographing device 1 and the object position.

Furthermore, direction information indicating the direction of the object can be included in the resource information. By referring to this direction information, for example, it is also possible for media data obtained by photographing from the front of the object to be displayed in the center of a display screen, and for media data obtained by photographing from the side of the object to be displayed at the side of the display screen.

Furthermore, in a case where there are a plurality of playback devices 3 as in (b) of the same drawing, media data having associated therewith resource information that includes position information corresponding to the positions of the playback devices 3 may be displayed. For example, it is also possible for media data in which an object that is in front and diagonally left of the photographing position has been captured, to be played by a playback device 3 that is in front and diagonally left of the user, and for media data in which an object that is in front of the photographing position has been captured, to be played by a playback device 3 that is in front of the user. In this way, the resource information can also be used for synchronized playback of media data in a plurality of playback devices 3.

### [Main Configuration of Devices]

Next, the main configuration of the devices included in the media-related information generation system 100 will be described based on FIG. 1. FIG. 1 is a block diagram depicting an example of the main configuration of the devices included in the media-related information generation system 100.

### [Main Configuration of Photographing Device]

The photographing device 1 is provided with: a control unit 10 that integrally controls the units of the photographing device 1; a photographing unit 11 that captures a video (still image or video image); a storage unit 12 that stores various types of data used by the photographing device 1; and a communication unit 13 for the photographing device 1 to communicate with other devices. Furthermore, the control unit 10 includes a photographing information acquisition unit (information acquisition unit) 16, a target information acquisition unit (information acquisition unit) 17, a resource information generation unit (description information generation unit) 18, and a data transmission unit 19. It should be noted that the photographing device 1 may be provided with functions other than photographing, and may be a multifunction device such as a smartphone, for example.

The photographing information acquisition unit 16 acquires information relating to photographing executed by the photographing unit 11. Specifically, the photographing information acquisition unit 16 acquires time information indicating a photographing time, and position information indicating a photographing position. It should be noted that the photographing position is the position of the photographing device 1 when photographing has been carried out. The method for acquiring position information indicating the position of the photographing device 1 is not particularly restricted; however, in a case where the photographing device 1 is provided with a function for acquiring position information using GPS, for example, the position information may be acquired using the function. Furthermore, the photographing information acquisition unit 16 also acquires direction information indicating the direction (photographing direction) of the photographing device 1 during photographing.

The target information acquisition unit 17 acquires information relating to a predetermined object within a video captured by the photographing unit 11. Specifically, the target information acquisition unit 17 analyzes (depth analysis) the video captured by the photographing unit 11, and thereby specifies the distance to the predetermined object within the video (a photographic subject in focus in the video). Position information indicating the position of the object is then calculated from the specified distance and the photographing position acquired by the photographing information acquisition unit 16. Furthermore, the target information acquisition unit 17 also acquires direction information indicating the direction of the object. It should be noted that a device that measures distance, such as an infrared distance meter or a laser distance meter, may be used to specify the distance to the object.

The resource information generation unit 18 generates resource information using the information acquired by the photographing information acquisition unit 16 and the information acquired by the target information acquisition unit 17, and adds the generated resource information to media data obtained by the photographing carried out by the photographing unit 11.

The data transmission unit 19 transmits the media data generated by the photographing carried out by the photographing unit 11 (the media data having added thereto the resource information generated by the resource information generation unit 18) to the server 2. It should be noted that the transmission destination of the media data is not restricted to the server 2, and the media data may be transmitted to the playback device 3, or may be transmitted to another device other than these. Furthermore, in a case where the photographing device 1 is provided with a playback function, media data may be played using the generated resource information, and, in this case, the media data does not have to be transmitted.

### [Main Configuration of Server]

The server 2 is provided with: a server control unit 20 that integrally controls the units of the server 2; a server communication unit 21 for the server 2 to communicate with other devices; and a server storage unit 22 that stores various types of data used by the server 2. Furthermore, the server control unit 20 includes a data acquisition unit (target information acquisition unit, photographing information acquisition unit, target information acquisition unit) 25, a resource information generation unit (description information generation unit) 26, a playback information generation unit 27, and a data transmission unit 28.

The data acquisition unit 25 acquires media data. Furthermore, the data acquisition unit 25 generates position information of an object in a case where resource information has not been not added to acquired media data, or in a case where position information of the object is not included in added resource information. Specifically, the data acquisition unit 25 specifies the position of an object within each video by video analysis of a plurality of items of media data, and generates position information indicating the specified position.

The resource information generation unit 26 generates resource information that includes the position information generated by the data acquisition unit 25. It should be noted that the generation of resource information by the resource information generation unit 26 is carried out in a case where the data acquisition unit 25 has generated position information. The resource information generation unit 26 generates resource information in a manner similar to the resource information generation unit 18 of the photographing device 1.

The playback information generation unit 27 generates playback information on the basis of at least either of the resource information added to media data acquired by the data acquisition unit 25 and the resource information generated by the resource information generation unit 26. Here, an example in which generated playback information is added to media data is described; however, generated playback information may be distributed and circulated separately from media data. By distributing the playback information, it becomes possible for resource information and media data to be used by a plurality of playback devices 3.

The data transmission unit 28 transmits media data to the playback device 3. The aforementioned resource information is added to this media data. It should be noted that resource information may be transmitted separately from media data. In this case, the resource information of a plurality of items of media data may be consolidated and transmitted as total resource information. The total resource information may be binary data or may be structured data such as XML (eXtensible Markup Language). Furthermore, the data transmission unit 28 also transmits playback information in a case where the playback information generation unit 27 has generated playback information. It should be noted that the playback information may be transmitted added to media data, similar to the resource information. The data transmission unit 28 may transmit media data in response to a request from the playback device 3, or may transmit media data regardless of requests.

### [Main Configuration of Playback Device]

The playback device 3 is provided with: a playback device control unit 30 that integrally controls the units of the playback device 3; a playback device communication unit 31 for the playback device 3 to communicate with other devices; a playback device storage unit 32 that stores various types of data used by the playback device 3; and a display unit 33 that displays a video. Furthermore, the playback device control unit 30 includes a data acquisition unit 36, an environment information generation unit 37, and a playback control unit 38. It should be noted that the playback device 3 may be provided with functions other than the playback of media data, and may be a multifunction device such as a smartphone, for example.

The data acquisition unit 36 acquires media data to be played by the playback device 3. In the present embodiment, the data acquisition unit 36 acquires media data from the server 2, but may acquire media data from the photographing device 1 as mentioned above.

The environment information generation unit 37 generates environment information. Specifically, the environment information generation unit 37 acquires identification information (ID) of the playback device 3, position information indicating the position of the playback device 3, and direction information indicating the direction of a display face of the playback device 3, and generates environment information including these items of information.

The playback control unit 38 carries out playback control for media data with reference to at least any of the resource information, playback information, and environment information. The details of the playback control using these items of information will be described later on.

### [Resource Information Generation Entity and Resource Information Corresponding to Generation Entity]

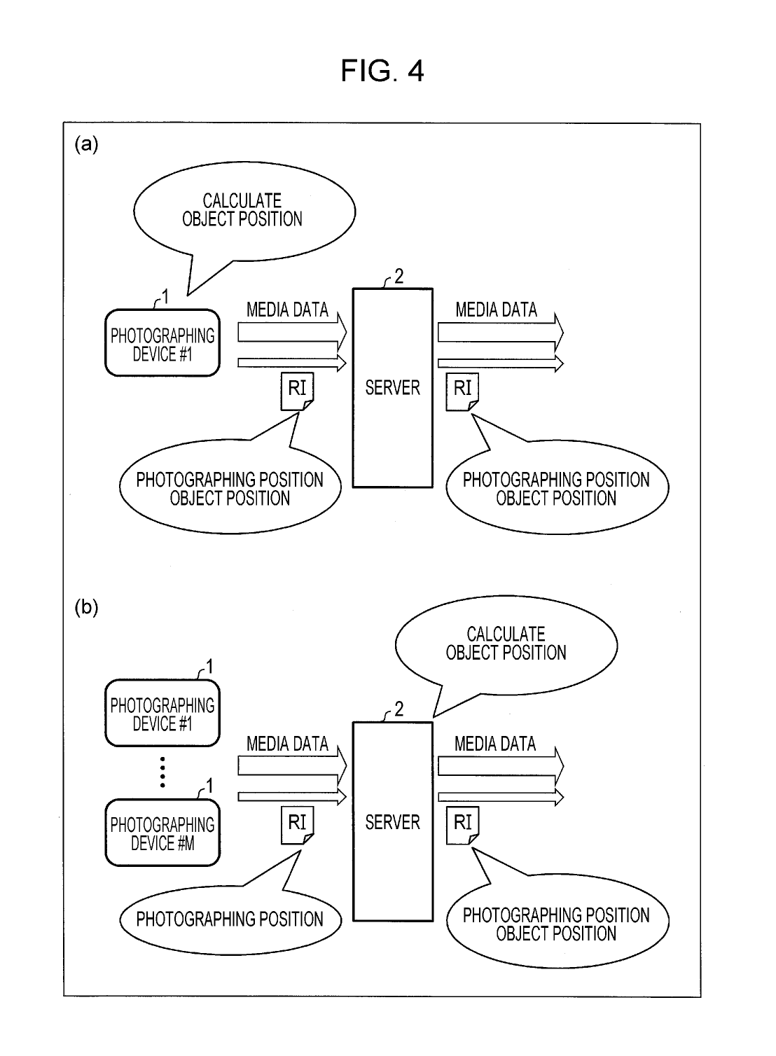

Next, a resource information generation entity and resource information corresponding to the generation entity will be described based on FIG. 4. FIG. 4 is a drawing depicting an example of the photographing device 1 generating resource information, and an example of the photographing device 1 and the server 2 generating resource information.

An example of the photographing device 1 generating resource information is depicted in (a) of the same drawing. In this example, the photographing device 1 generates media data by photographing and also generates position information indicating a photographing position, and, in addition, calculates the position of a captured object and also generates position information indicating the position of the captured object. Thus, resource information (RI) that is transmitted to the server 2 by the photographing device 1 indicates both the photographing position and the position of the object. In this case, in the server 2, it is not necessary to generate resource information, and it is sufficient for resource information acquired from the photographing device 1 to be transmitted as it is to the playback device 3.

Meanwhile, an example of the photographing device 1 and the server 2 generating resource information is depicted in (b) of the same drawing. In this example, the photographing device 1 transmits resource information that includes position information indicating a photographing position, to the server 2 without calculating the position of an object. Next, the data acquisition unit 25 of the server 2 carries out image analysis on media data received from each photographing device 1 to detect the position of an object in each item of media data. By obtaining the position of the object, it becomes possible to obtain the relative position of the photographing device 1 with respect to the object. Thus, the data acquisition unit 25 obtains the position of the object in each item of media data, using the photographing position indicated by the resource information received from the photographing device 1, namely the position of the photographing device 1 during photographing, and the detected position of the object. The resource information generation unit 26 of the server 2 then generates resource information indicating the photographing position indicated by the resource information received from the photographing device 1, and the position of the object obtained as mentioned above, and transmits the generated resource information to the playback device 3.

It should be noted that a method for specifying the position of an object by using a marker may be adopted instead of the methods of (a) and (b) of the same drawing. That is, an object having known position information may be set in advance as a marker, and for a video in which that marker is a photographic subject, the known position information may be applied as position information of the object.

### [Description/Control Units of Playback Information]

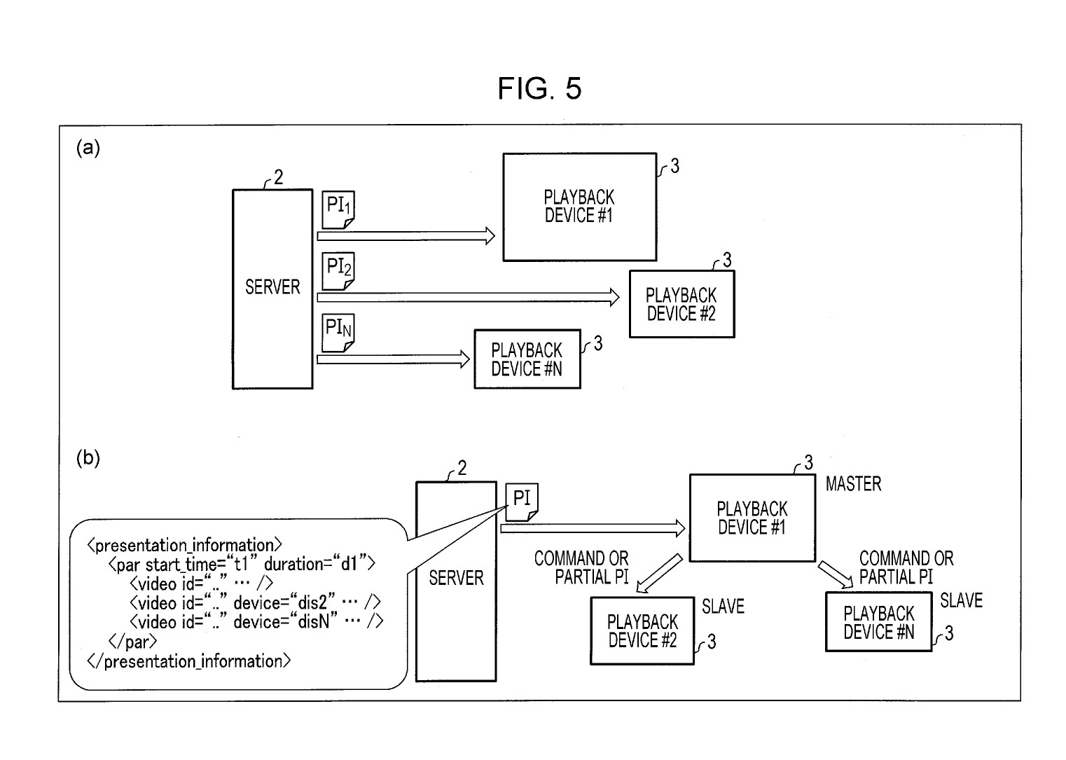

As depicted in FIG. 2, playback information is transmitted to playback devices 3 from the server 2 and is used for the playback of media data; however, playback information may be transmitted to each of the playback devices 3 that are to play the media data, or may be transmitted to some of the playback devices 3 that are to play the media data. This will be described based on FIG. 5. FIG. 5 is a drawing depicting an example of description/control units of playback information.

An example of playback information being transmitted to each playback device 3 that is to play media data is depicted in (a) of the same drawing. In this case, the server 2 respectively generates playback information corresponding to each playback device 3, and transmits the playback information to the playback device 3 corresponding to the playback information in question. For example, in the depicted example, N types of PI₁ to PI_{N} playback information are generated for N number of #1 to #N playback devices 3. The PI₁ playback information generated for the #1 playback device 3 is then transmitted to the playback device 3. Furthermore, similarly, the playback information generated for the #2 and thereafter playback devices 3 is transmitted to the playback devices 3. It should be noted that the playback information of each playback device 3 may be generated based on environment information acquired from the playback device 3 in question, for example.

Meanwhile, an example of playback information being transmitted to one of the playback devices 3 that are to play media data is depicted in (b) of the same drawing. In more detail, from among the N number of #1 to #N playback devices 3, playback information is transmitted to a playback device 3 that has been set as a master (hereinafter, referred to as the master). The master then transmits a command or partial PI (a portion of the playback information acquired by the master) to playback devices 3 that have been set as slaves (hereinafter, referred to as the slaves). Thus, similar to the example of (a) of the same drawing, it becomes possible for media data to be played in a synchronized manner in each playback device 3.

As in (b) of the same drawing, in a case where playback information is transmitted to only a portion of the playback devices 3 (the master), both information that stipulates an operation of the master and information that stipulates an operation of the slaves are described in the playback information. For example, in the playback information (presentation_information) that is transmitted to the master in the depicted example, IDs of videos to be played at the same time from a start time t1 and for a period d1 are listed, and also information indicating the device to display the video in question is associated with each ID. Specifically, information (dis2) designating the #2 playback device 3 is associated with the second ID (video ID), and information (disN) designating the #N playback device 3 is associated with the third ID. It should be noted that the first ID for which there is no designation of a device designates the master.

Thus, the master which has received the playback information of the same drawing decides that the video having the first ID is to be played from the time t1. Furthermore, the master decides that the video having the second ID is to be played from the time t1 by the #2 playback device 3 which is a slave, and also that the video having the third ID is to be played from the time t1 by the #N playback device 3 which is a slave. The master then transmits a command (an instruction including the time t1 and information indicating the playback-target video) or a portion of the playback information (a portion including information relating to the transmission-destination slave) to the slaves. According to a configuration such as this, it becomes possible for media data to be played in a synchronized manner from the time t1 by the #1 to #N playback devices 3.

### [Example of Resource Information (Still Image)]

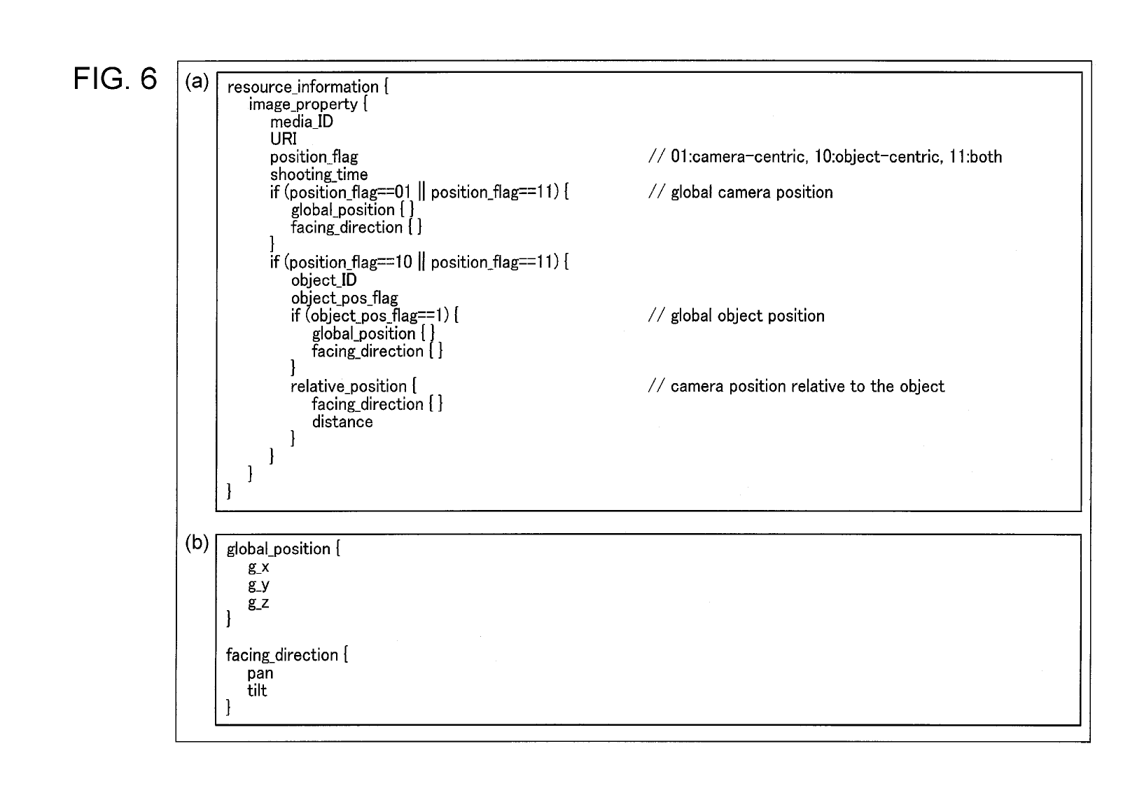

Next, an example of the resource information will be described based on FIG. 6. FIG. 6 is a drawing depicting an example of syntax for resource information for a still image. In resource information according to the depicted syntax, a media ID (media_ID), a URI (Uniform Resource Identifier), a position flag (position_flag), a photographing time (shooting_time), and position information can be described as the properties of an image (image property). The media ID is an identifier that uniquely specifies a captured image, the photographing time is information that indicates the time at which the image was captured, and the URI is information that indicates the address for the actual data of the captured image. A URL (Uniform Resource Locator), for example, may be used as the URI.

The position flag is information that indicates the recording format of the position information (information indicating which position information is included out of the position information acquired by the target information acquisition unit 17 and the position information acquired by the photographing information acquisition unit 16). In the depicted example, in a case where the value of the position flag is “01”, (camera-centric) position information based on the photographing device 1, acquired by the photographing information acquisition unit 16, is included. However, in a case where the value of the position flag is “10”, (object-centric) position information based on an object that is a photographing target, acquired by the target information acquisition unit 17, is included. Also, in a case where the value of the position flag is “11”, position information of both of these formats is included.

Specifically, for position information that is based on the photographing device, position information (global_position) indicating the absolute position of a photographing device, and direction information (facing_direction) indicating the direction (photographing direction) of the photographing device can be described. It should be noted that global_position indicates a position in a global coordinate system. In the depicted example, the two rows after “if (position_flag==01∥position_flag==11) (” are position information that is based on a photographing device.

However, for position information that is based on an object, an object ID (object_ID) that is an identifier of the object to be based on, and an object position flag (object_pos_flag) that indicates whether or not the position of the object is included can be described. In the depicted example, the nine rows after “if (position_flag==10∥position_flag==11) {” are position information that is based on an object.

It should be noted that, in a case where the object position flag has the value (1), as depicted, position information (global_position) indicating the absolute position of the object, and direction information (facing_direction) indicating the direction of the object are described. In addition, relative position information (relative_position) of the photographing device with respect to the object, direction information (facing_direction) indicating the photographing direction, and the distance (distance) from the object to the photographing device can also be described.

The object position flag is taken as “0” such as when a common object is included in videos captured by a plurality of photographing devices 1 in a case where resource information is to be generated by the server 2, for example. In a case where the object position flag is taken as “0”, the position information of the common object in question is described only once, and when reference is made to the position information thereafter, reference is made by way of the ID of the object in question. The description amount of the resource information can thereby be reduced compared to a case where all position information of the object is described. However, even with the same object, it is possible for the position thereof to change if the photographing time is different. In other words, to be precise, if there is an object having the same photographing time and there is also already a description of the position information of that object, describing the position information can be omitted, but if there is no such description, the position information is described. Furthermore, in a case where it is desired for recorded still images to be made independent in order to be utilized for a variety of uses, the object position flag may be always set to “0”, and absolute position information may be written for each still image.

It should be noted that, even if an object is common, the photographing position is different for each photographing device 1, and therefore all relative position information of the photographing devices 1 is described even in a case where the object position flag has been set to “0”.

Here, an example has been described in which direction information indicating the direction of an object is information that indicates the front direction of an object; however, the direction information is not restricted to indicating the front direction provided that the direction information indicates a direction of an object. For example, the direction information may indicate the rear direction of an object.

The aforementioned position information and direction information may be described in a format such as that depicted in (b) of the same drawing, for example. The position information (global_position) of (b) of the same drawing is information indicating a position in a space defined by three axes (x, y, z) that are orthogonal to each other. It should be noted that the position information may be position information of the three axes, or, for example, latitude, longitude, and altitude may be used as the position information. Furthermore, in a case where, for example, resource information for images captured in an event venue is to be generated, the three axes (x, y, z) may be set based on a starting point that has been set at a prescribed position in the event venue in question, and a position within the space defined by these three axes may serve as position information.

Furthermore, the direction information (facing_direction) of (b) of the same drawing is information in which the photographing direction or the direction of an object is indicated by a combination of an angle in the horizontal direction (pan) and an elevation angle or inclination angle (tilt). As depicted in (a) of the same drawing, the direction information (facing_direction) and the distance from an object to a photographing device (distance) are included in the relative position information (relative_position).

In the direction information, an azimuth (bearing) may be used as information indicating an angle in the horizontal direction, and a tilt angle with respect to the horizontal direction may be used as information indicating the elevation angle or inclination angle. In this case, in global coordinates, the angle in the horizontal direction can be expressed by a value that is 0 or more and less than 360 in the clockwise direction with north as 0, and, in local coordinates, can be expressed by a value that is 0 or more and less than 360 in the clockwise direction with the starting point direction as 0. It should be noted that the starting point direction may be set as appropriate, and, for example, when the photographing direction is to be expressed, the direction from the photographing device 1 to an object may serve as 0.

Furthermore, in a case where the front of an object is uncertain, it is preferable that the direction information of the object explicitly indicate that the front is uncertain, as a value that is not used in a case where an ordinary direction is indicated, such as −1 or 360, for example. It should be noted that the default value for the angle in the horizontal direction (pan) may be 0.

Furthermore, in a case where the photographing device 1 is a 360-degree camera (a camera with which the range that can be captured in one shot extends across the 360 circumference of the photographing device 1, also referred to as a omnidirectional camera), the photographing direction of the photographing device 1 is omnidirectional, and it becomes possible for videos in all directions surrounding the photographing device 1 to be extracted. In this case, it is preferable that information capable of specifying that the photographing device 1 is a 360-degree camera, or that it is possible for videos in all directions to be extracted, be described. For example, it may be explicitly indicated that the photographing device 1 is a 360-degree camera with the value for the angle in the horizontal direction (pan) being 361. Furthermore, for example, the values for the angle in the horizontal direction (pan) and the elevation angle or inclination angle (tilt) may be set to default values (0) and a descriptor indicating that photographing has been performed by a omnidirectional camera may be prepared separately, and this may be described in the resource information.

### [Example of Resource Information (Video Image)]

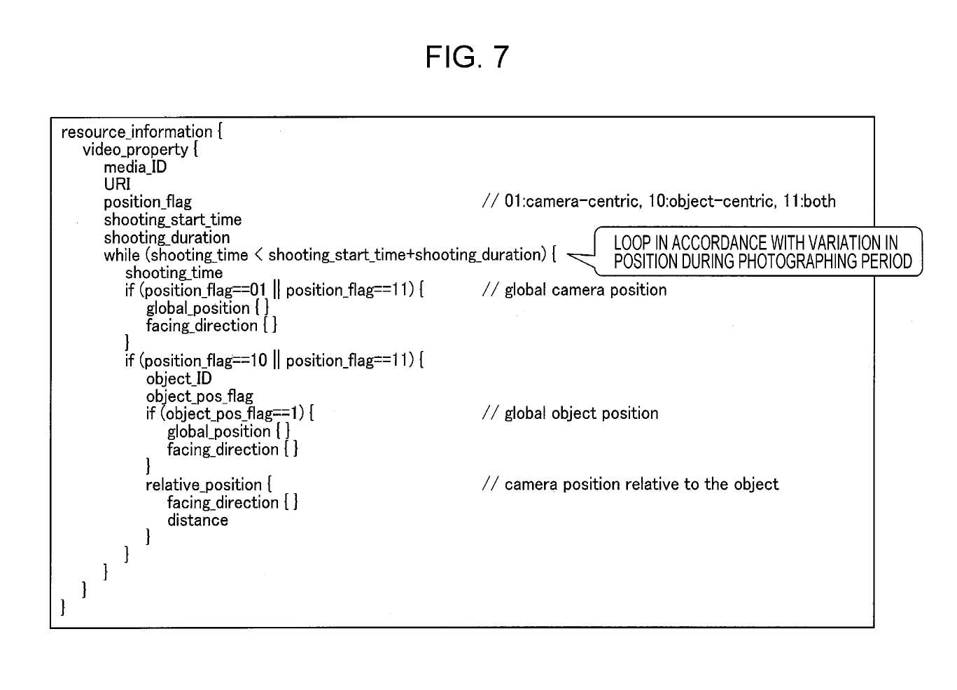

Following on, an example of resource information for a video image will be described based on FIG. 7. FIG. 7 is a drawing depicting an example of syntax for resource information for a video image. The depicted resource information is generally similar to the resource information of (a) of FIG. 6; however, there is a difference in that a photographing start time (shooting_start_time) and a photographing continuation time (shooting_duration) are included.

In the case of a video image, the positions of the photographing device and the object can change during photographing, and therefore position information is included in the resource information at each predetermined continuation time. That is, while photographing is continuing, processing for describing, in the resource information, a combination of the photographing time and position information corresponding to that time is (repeatedly) executed, looping at each predetermined continuation time. Thus, the combination of the photographing time and position information corresponding to that time is repeatedly described at each predetermined continuation time in the resource information for a video image. The predetermined continuation time mentioned here may be a regular fixed interval of time, or may be an irregular unfixed interval of time. In the case of being irregular, an unfixed interval of time is decided by detection of the photographing position having changed, the object position having changed, or the photographing target having moved to another object, and the time of that detection being registered.

### [Processing Flow for Generating Resource Information (Still Image)]

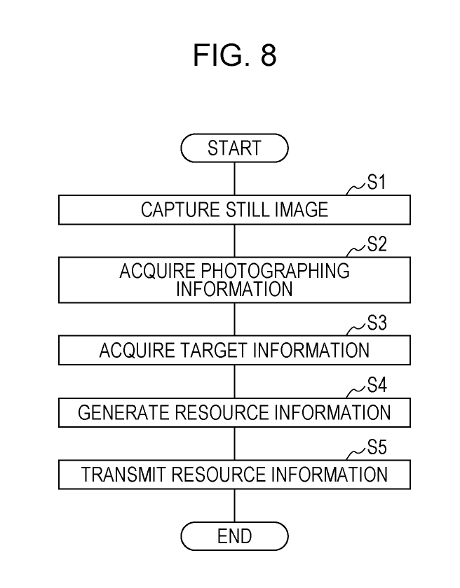

Next, the processing flow for generating resource information in a case where the media data is a still image will be described based on FIG. 8. FIG. 8 is a flowchart depicting an example of processing for generating resource information in a case where the media data is a still image.

In the photographing device 1, when the photographing unit 11 captures a still image (S1), the photographing information acquisition unit 16 acquires photographing information (S2), and the target information acquisition unit 17 acquires target information (S3). In more detail, the photographing information acquisition unit 16 acquires time information indicating a photographing time and position information indicating a photographing position, and the target information acquisition unit 17 acquires position information of an object and direction information of the object.

The resource information generation unit 18 then generates resource information using the photographing information acquired by the photographing information acquisition unit 16 and the target information acquired by the target information acquisition unit 17 (S4), and outputs the resource information to the data transmission unit 19. In the present example, since the target information is acquired in S3, the resource information generation unit 18 sets the value of the position flag to “10”. It should be noted that, in a case where position information based on the photographing device 1 is also described, the value of the position flag is set to “11”. Furthermore, in a case where the processing of S3 is not carried out and only position information based on the photographing device 1 is described, the value of the position flag is set to “01”.

Finally, the data transmission unit 19 transmits media data having associated therewith the resource information generated in S4 (media data of the still image generated by the photographing of S1), to the server 2 via the communication unit 13 (S5), and the depicted processing thereby ends. It should be noted that the transmission destination of the resource information is not restricted to the server 2, and the resource information may be transmitted to the playback device 3, for example. Furthermore, in a case where the photographing device 1 is provided with a playback (display) function for still images, the generated resource information may be used to play (display) a still image in the photographing device 1, and, in this case, S5 in which the resource information is transmitted may be omitted.

### [Processing Flow for Generating Resource Information (Video Image)]

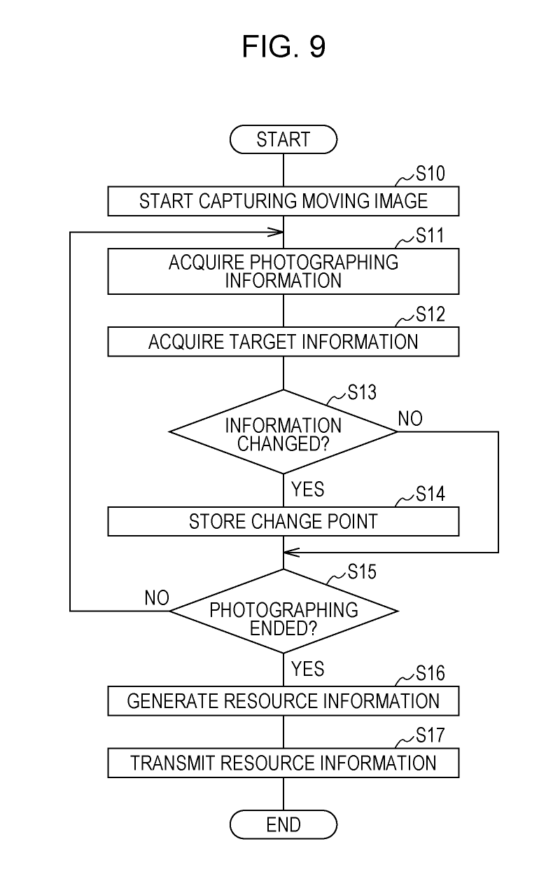

Following on, the processing flow for generating resource information in a case where the media data is a video image will be described based on FIG. 9. FIG. 9 is a flowchart depicting an example of processing for generating resource information in a case where media data is a video image.

When the photographing unit 11 starts capturing a video image (S10), the photographing information acquisition unit 16 acquires photographing information (S11), and the target information acquisition unit 17 acquires target information (S12). The photographing information acquisition unit 16 then outputs the acquired photographing information to the resource information generation unit 18, and the target information acquisition unit 17 outputs the acquired target information to the resource information generation unit 18. This processing of S11 and S12 is carried out each time the predetermined continuation time elapses, until it is determined in the subsequent S15 that photographing has ended (yes in S15).

Next, the resource information generation unit 18 determines whether at least either of the photographing information and target information generated in the processing of S11 and S12 has changed (S13). This determination is executed in a case where the processing of S11 and S12 has been carried out two or more times, and is carried out by comparing the values of the photographing information and target information generated the immediately preceding time and the values of the photographing information and target information generated subsequently thereafter. In S13, it is determined that the photographing information has changed in a case where at least either of the position (photographing position) and the direction (photographing direction) of the photographing device 1 has changed. Furthermore, it is determined that the target information has changed in a case where at least either of the position and direction of the object has changed, or in a case where the photographing target has moved to another object.

Here, in a case where it is determined that there has been no change (no in S13), processing proceeds to S15. However, if it is determined that there has been a change (yes in S13), the resource information generation unit 18 stores the point of change (S14). That is, the resource information generation unit 18 stores the time at which it is determined that there has been a change, and also stores information regarding which one has changed from among the photographing information and target information (information regarding both in a case where both have changed).

If it is determined that photographing has ended (yes in S15), the resource information generation unit 18 generates resource information using the photographing information output by the photographing information acquisition unit 16, the target information output by the target information acquisition unit 17, and the aforementioned information stored at the point of change (S16). In more detail, the resource information generation unit 18 generates resource information in which photographing information and target information at the beginning and the point of change are described. In other words, the resource information generated in S16 is information in which the set of the photographing information and target information is looped for the number of points of change detected at the beginning and in the processing of S11 to S15. The resource information generation unit 18 then outputs the generated resource information to the data transmission unit 19.

Finally, the data transmission unit 19 transmits media data having associated therewith the resource information generated in S14 (media data generated by the photographing started in S10), to the server 2 via the communication unit 13 (S15), and the depicted processing thereby ends.

It should be noted that, in the aforementioned example, a point of change is detected by determining whether at least either of the photographing information and target information has changed at each predetermined continuation time (S13); however, the method for detecting a point of change is not restricted to this example. For instance, in a case where the photographing device 1 or another device is provided with a function for detecting a change in the photographing position, the photographing direction, the position of an object, the direction of an object, and the photographing-target object, a point of change may be detected by using the function. It is also possible for a change in the photographing position and a change in the photographing direction to be detected by using, for example, an acceleration sensor or the like. Furthermore, it is also possible for a change (movement) in the position and direction of an object to be detected by, for example, a color sensor, an infrared sensor, or the like. In a case where a detection function of another device is used, it is possible for a point of change to be detected in the photographing device 1 by a notification being transmitted from the other device in question to the photographing device 1. Furthermore, the processing of S13 and S14 may be omitted, and the photographing information and target information of a fixed interval of time may be recorded. In that case, resource information is generated having been looped for the number of times that looping has been carried out in the processing of S11 to S15.

### [Example of Environment Information]

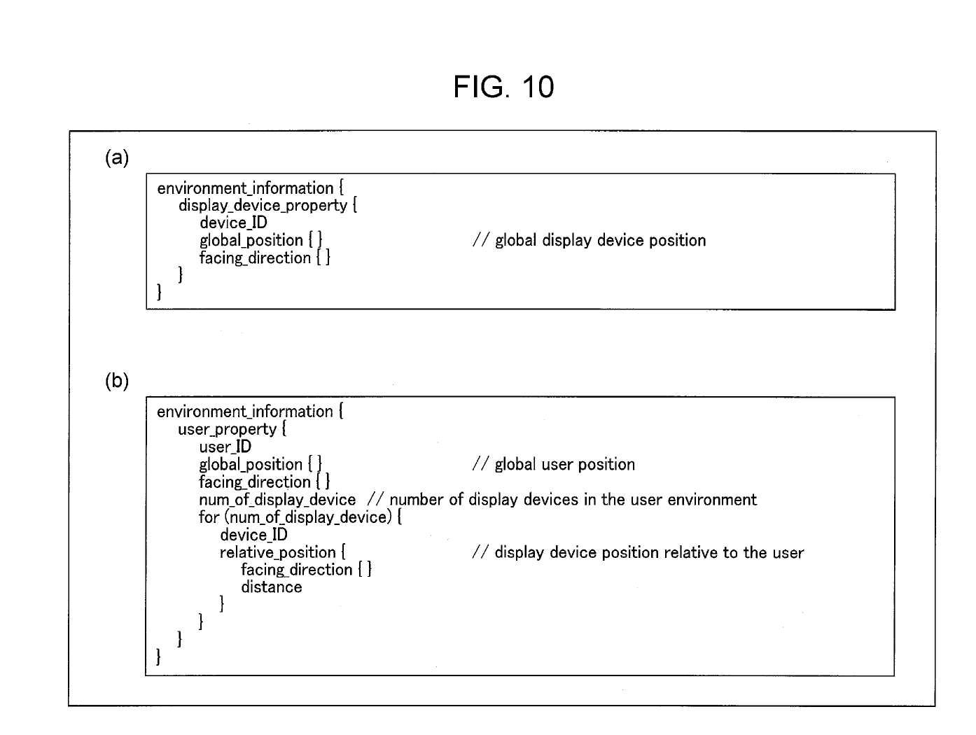

Next, an example of environment information EI will be described based on FIG. 10. FIG. 10 is a drawing depicting an example of syntax for environment information. An example of environment information (environment_information) described with regard to a device that displays a video (the playback device 3 in the present embodiment) is depicted in (a) of the same drawing. This environment information includes the ID of the playback device 3, position information (global_position) of the playback device 3, and direction information (facing_direction) indicating the direction of the display face of the playback device 3, as properties (display_device_property) of the playback device 3. Thus, by referring to the depicted environment information, it is possible to specify what kind of position and what kind of direction in which the playback device 3 is arranged.

Furthermore, as depicted in (b) of the same drawing, it is also possible for environment information of each user to be described. The environment information of (b) of the same drawing includes the ID of a user, position information (global_position) of the user, direction information (facing_direction) indicating the front direction of the user, and the number (num_of_display_device) of devices displaying a video (the playback device 3 in the present embodiment) in the environment of the user, as properties of the user (user_property). Furthermore, an ID (device_ID), the relative position (relative_position) of the playback device 3 with respect to the user, direction information (facing_direction) indicating the direction of the display face, and distance information (distance) indicating the distance to the user is described for each playback device 3. The information from the device_ID to the distance loops (is repeated) for the number indicated in num_of_display_device. It should be noted that it is possible for reference to be made to the environment information of each playback device 3 such as that depicted in (a) of the same drawing, by using the device_ID. Therefore, in a case where the global position (global position) of each playback device 3 is to be specified using the environment information of (b) of the same drawing, the specifying is carried out with reference being made to the environment information of each playback device 3. Naturally, the global position (global position) of each playback device 3 may be described directly in the environment information of (b) of the same drawing.

In a case where the playback device 3 is a portable device possessed by user, the environment information generation unit 37 may acquire position information indicating the position of the playback device 3, and this may be described in the environment information as position information of the user. Furthermore, the environment information generation unit 37 may acquire position information of another device carried by the user from the other device (it is sufficient for the other device to be provided with a function for acquiring position information, and the other device may be another playback device 3), and may describe this in the environment information as position information of the user.

Furthermore, the environment information generation unit 37 may describe playback devices 3 that have been input to a playback device 3 by the user, in environment information as playback devices 3 that are in the environment of the user, or may describe automatically detected playback devices 3 that are within a viewable range of the user, in the environment information. Also, it is possible for an ID or the like of another playback device 3 described in the environment information to be described as a result of the environment information generation unit 37 acquiring environment information generated by the other playback device 3 in question, from the other playback device 3 in question.

It should be noted that, in the environment information of (b) of the same drawing, it is assumed that the position information (global position) of the playback device 3 is specified by referring to the environment information of each playback device 3 such as that in (a) of the same drawing, with the ID of the playback device 3 serving as a key. However, it goes without saying that the position information (global position) of the playback device 3 may be described in the environment information of the user.

### [Mapping of Media Data]

The media data can be mapped with reference being made to the resource information and the environment information. For example, by referring to position information (may be information indicating a photographing position or information indicating an object position) included in resource information in a case where the position information of a plurality of playback devices 3 is included in the environment information of each user, media data corresponding to the positional relationship therebetween can be extracted and played by each playback device 3. Furthermore, when mapping is carried out, scaling may be carried out in order to ensure conformity between intervals in positions indicated by the position information included in the resource information, and intervals in positions indicated by the position information included in the environment information. For example, a 2×2×2 imaging system may be mapped to a 1×1×1 display system, and, thereby, three videos captured at photographing positions having 2-m intervals arranged on a straight line can also be displayed by respective playback devices 3 arranged at 1-m intervals on a straight line.

Furthermore, the mapping range may be made to have some margin. For example, in a case where media data is to be mapped to a playback device 3 arranged in a position {xa, ya, za}, instead of strictly designating the photographing position as in {x1, y1, z1}, a photographing position having some margin may be designated as in {x1−Δ1, y1−Δ2, z1−Δ3} to {x1+Δ1, y1+Δ2, z1+Δ3}.

Other than the aforementioned, it is also possible to generate a video that corresponds to the position of the playback device 3 by referring to the resource information and the environment information. For example, in a case where media data corresponding to the position of a certain playback device 3 does not exist but media data corresponding to a nearby position does exist, media data corresponding to the position of the aforementioned certain playback device 3 may be generated by carrying out image processing such as interpolation on the nearby media data.

This kind of mapping and scaling may be carried out by the server 2 or may be carried out by the master playback device 3 depicted in (b) of FIG. 5. In a case where mapping and scaling is to be carried out by the server 2, it is sufficient for the server control unit 20 to be provided with an environment information acquisition unit that acquires environment information and a playback control unit that causes the playback device 3 to play media data. In this case, the playback control unit carries out mapping (and scaling as required) as mentioned above using environment information acquired by the environment information acquisition unit and resource information acquired by the data acquisition unit 25 or generated by the resource information generation unit 26. The playback control unit then causes media data to be transmitted to and played by each playback device 3 in accordance with the result of the mapping. It should be noted that the playback information generation unit 27 may carry out mapping and generate playback information that stipulates a playback mode according to the result of the mapping. In this case, playback in the playback mode in question is realized by transmitting the playback information to the playback device 3.

However, in a case where mapping is to be carried out by the master playback device 3, the playback control unit 38 carries out mapping as mentioned above using the environment information generated by the environment information generation unit 37 and the resource information acquired by the data acquisition unit 36. Media data is then transmitted to and played by each playback device 3 in accordance with the result of that mapping.

As mentioned above, a control device (server 2/playback device 3) of the present invention is characterized in being provided with: an environment information acquisition unit (the environment information generation unit 37) that acquires environment information indicating the arrangement of a display device (playback device 3); and a playback control unit (38) that causes the display device in the arrangement to play media data having added thereto resource information that includes position information corresponding to the arrangement indicated by the environment information.

It is thereby possible for a video that has been captured in a photographing position corresponding to the arrangement of the display device, or a video in which an object in a position corresponding to that arrangement has been captured, to be automatically displayed according to that arrangement.

### [Updating Environment Information]

The position of the user can vary and the position of the playback device 3 can vary, and it is therefore preferable that the environment information also be updated in accordance with variations in these positions. In this case, the environment information generation unit 37 of the playback device 3 monitors the position of the playback device 3 and updates the environment information when the position has changed. It should be noted that it is sufficient for the position to be monitored by periodically acquiring position information. Other than the aforementioned, for example, in a case where the playback device 3 is provided with a detection unit (for example, an acceleration sensor) that detects changes in the movement and position of the device itself, position information may be acquired when a change in the movement and position of the device itself has been detected by the detection unit. The position of the user may be monitored by acquiring position information from a device carried by the user such as a smartphone, for example, periodically from the device or when a change in the position of the device has been detected.

The environment information of each playback device 3 may be updated separately by each playback device 3. Meanwhile, the environment information of each user may be updated by the playback device 3 that generates the environment information acquiring environment information that has been updated by another playback device 3 from the other playback device 3, or may be updated by the other playback device 3 notifying mainly changes in position (the changed position or the updated environment information), to the playback device 3 that generates the environment information of each user.

Furthermore, in the updating of the environment information, the environment information generation unit 37 may overwrite position information from before a change with position information from after the change, or may add the position information from after the change with the position information from before the change remaining. In the case of the latter, similar to the description of position information in the resource information of a video image described based on FIG. 7, environment information (the environment information of each user or the environment information of each playback device 3) may be described in a loop formed of a combination of position information and time information indicating the acquisition time of the position information.

Environment information that includes time information indicates the movement history of the position of the user and the playback device 3. Therefore, by using environment information that includes time information, it is possible to reproduce a viewing environment that corresponds to the position of the user and the playback device 3 in the past, for example. Furthermore, in a case where at least either of the user and the playback device 3 carries out a movement that has been decided in advance, a planned end time for the movement may be described in the time information, and also the position from after the movement may be described as position information, in the environment information. Thus, a future arrangement of the user and the playback device 3 can be anticipated, and, by referring to the resource information, it also becomes possible for a video that corresponds to the arrangement indicated in the environment information to be automatically specified.

As mentioned above, a generation device (playback device 3) of the present invention is a generation device that generates environment information indicating the arrangement of a display device (playback device 3), characterized in being provided with an environment information generation unit that respectively acquires position information indicating the position of the display device at a plurality of different points in time, and generates environment information including the position information at the plurality of different points in time. Thus, it becomes possible for the display device to be made to display a video that corresponds to a past position of the display device or a future anticipated position of the display device.

### [Details of Playback Information]

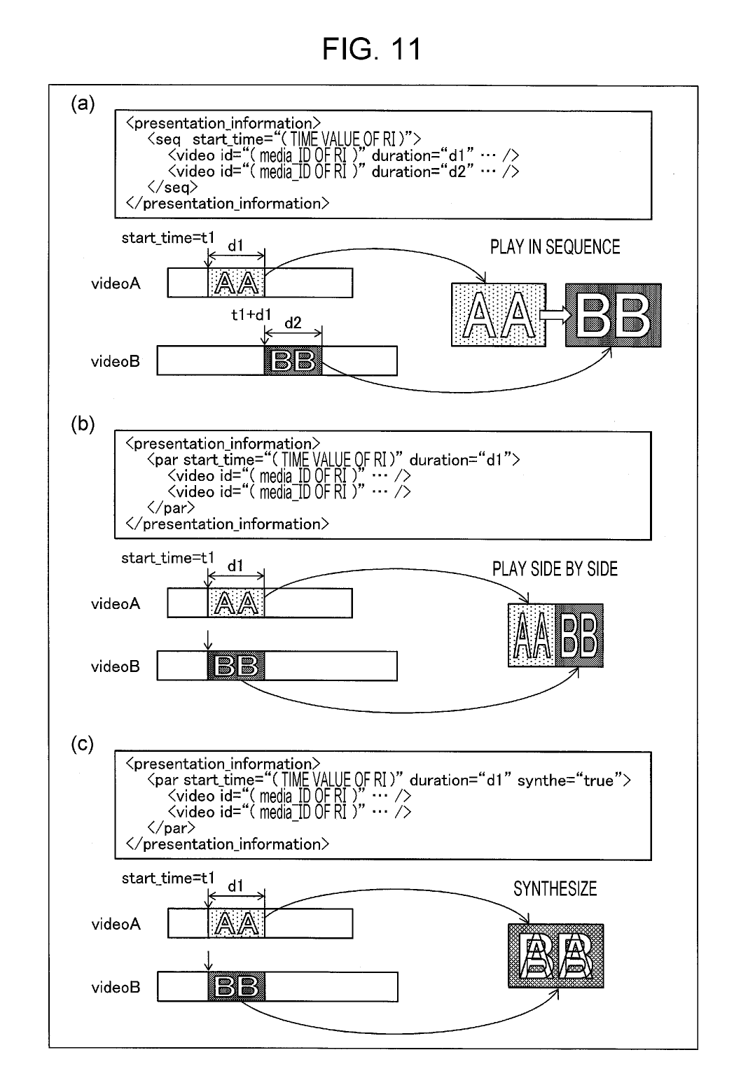

Following on, the details of playback information PI (presentation_information) will be described based on FIGS. 11 to 18.

### Example 1 of Playback Information

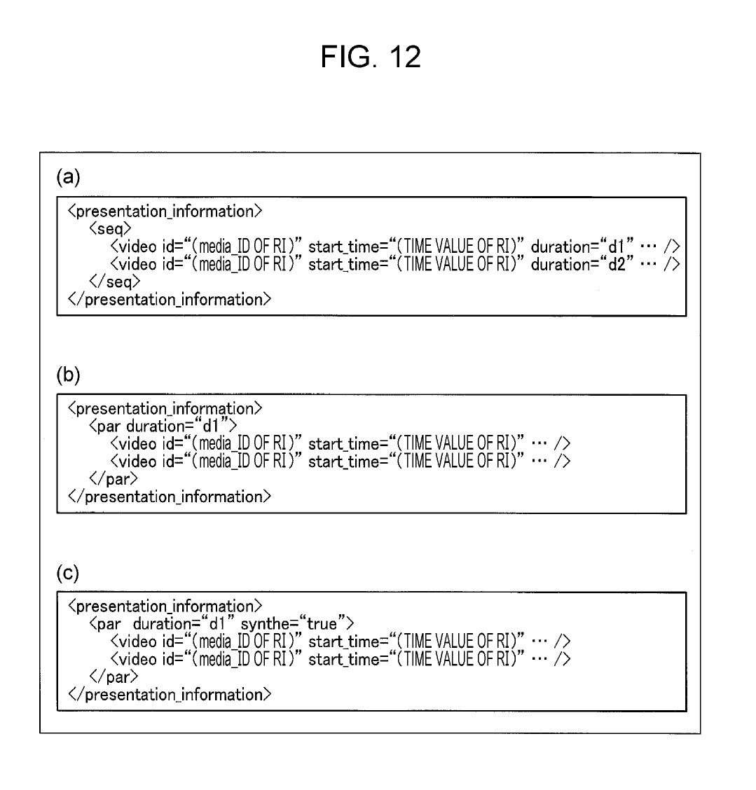

FIG. 11 is a drawing depicting an example of playback information stipulating a playback mode for two items of media data. Specifically, playback information described using seq tags (the playback information of (a) in FIG. 11; similar for FIG. 12 and thereafter) indicates that two items of media data (specifically, two items of media data corresponding to two elements enclosed by seq tags) are to be played successively.

Similarly, playback information described using par tags (the playback information of (b) and (c) in FIG. 11; similar for FIG. 12 and thereafter) indicates that two items of media data are to be played in a parallel manner.

Furthermore, playback information described using par tags in which the attribute value of a synthe attribute is “true” (the playback information of (c) in FIG. 11; similar for FIG. 12 and thereafter) indicates that two items of media data are to be played in a parallel manner in such a way that two videos (still image or video image) corresponding to the two items of media data are displayed in a superimposed manner. It should be noted that playback information described using par tags in which the attribute value of the synthe attribute is not “true” (is “false”) indicates that two items of media data are to be played in a parallel manner, similar to the playback information of (b) in FIG. 11. It should be noted that a start_time attribute within each item of playback information in FIG. 11 indicates the photographing time of media data. The start_time attribute indicates the photographing time in a case where the media data is a still image, and indicates a specific time from a photographing start time to an end time in the case of a video image. That is, for a video image, by designating a time with the start_time attribute, playback can be started from the portion captured at that time.

It should be noted that the playback information in FIG. 11 (similar for FIG. 12 and thereafter) describes only the time of the media data to be played (the start_time attribute in the example of FIG. 11), and does not describe the time of playback (information such as the hour and minute at which this media data is to be played). However, it is also possible for a playback time to be designated, and playback can be designated at a specific time by describing a playback start time (presentation_start_time) in playback information separately, for example.

Hereinafter, a playback mode for two items of media data for which the playback device 3 refers to the playback information of (a) of FIG. 11 will be specifically described. The playback control unit 38 having acquired the playback information of (a) of FIG. 11 from the data acquisition unit 36, first, decides that the first item of media data (the media data corresponding to the first video tag from the top) is a playback target. Then, from within this media data, a portion (partial video) captured in a first period designated by the playback information in question is played.

Specifically, the playback control unit 38 plays a partial video captured in a period having a length d1 indicated by the attribute value of a duration attribute of the video tag corresponding to the first item of media data, starting at the time t1 indicated by the attribute value of the start_time attribute of the seq tag. An illustration of videoA given below the PI in the same drawing depicts such processing in a concise manner. In other words, the left end of the white rectangle represents the photographing start time of videoA (media data corresponding to the first video tag), and the right end represents the photographing end time of videoA. It is also indicated that the partial video having the length d1 is played from the time t1 between the photographing start time and the photographing end time, and, as a result of this playback, an image depicting AA is displayed in the d1 period.

When playback of the partial video relating to the first item of media data has been completed, the playback control unit 38 plays a portion (partial video) captured in a second period (the period immediately after the first period) of the second item of media data (media data corresponding to the second video tag from the top). Specifically, the playback control unit 38, for the second item of media data, plays a partial video captured in a period that starts at the time (t1+d1) and has a length d2 indicated by the attribute value of the duration attribute of the video tag.

An illustration of videoB given below the PI in the same drawing depicts such processing in a concise manner. Similar to videoA, the left end of the white rectangle represents the photographing start time of videoB (media data corresponding to the second video tag), and the right end represents the photographing end time. It is also indicated that a partial video having the length d2 is played from the time t1+d1 between the photographing start time and the photographing end time, and, as a result of this playback, an image depicting BB is displayed in the d2 period. It should be noted that, in the drawing, the size of the white rectangle is different between videoA and videoB (the positions of the left ends and the positions of the right ends), and this indicates that the photographing start times and the photographing end times of each item of media data included in the PI may deviate.

Next, a playback mode for two items of media data for which the playback device 3 refers to the playback information of (b) of FIG. 11 will be specifically described. The playback control unit 38 having acquired the playback information of (b) of FIG. 11 plays a portion (partial video) captured in a specific period designated by the playback information, of each of the two items of media data. Here, the specific period is a period that starts at the time t1 indicated by the attribute value of the start_time attribute of the par tag, and has the length d1 (indicated by the attribute value of the duration attribute of the par tag).

Specifically, the playback control unit 38, with a display region of the display unit 33 (a display) being divided into two, displays the partial video of the first item of media data in one region (for example, the left-side region), and, at the same time, displays the partial video of the second item of media data in the other region (for example, the right-side region).

In addition, a playback mode for two items of media data for which the playback device 3 refers to the playback information of (c) of FIG. 11 will be specifically described. The playback control unit 38 having acquired the playback information of (c) of FIG. 11 plays a portion (partial video) captured in a specific period (the aforementioned period indicated by the start_time attribute and the duration attribute of the par tag) designated by the playback information, of each of the two items of media data. In this playback information, the attribute value of synthe is “true”, and these partial videos are therefore displayed in a superimposed manner.

Specifically, the playback control unit 38 plays the two partial videos in a parallel manner in such a way that the partial video of the first item of media data and the partial video of the second item of media data can be seen superimposed. For example, the playback control unit 38 displays a video in which the partial videos have been synthesized in a semi-transparent manner by alpha blending processing. Alternatively, the playback control unit 38 may display one of the partial videos on the entire screen and wipe-display the other partial video.

As mentioned above, a playback device (3) of the present invention is characterized in being provided with a playback control unit (38) that sets, as a playback target, media data having added thereto resource information that includes time information indicating that photographing has been started at a predetermined time or photographing has been carried out at a predetermined time, from among a plurality of items of media data having added thereto resource information. Thus, media data extracted based on time information from among a plurality of items of media data can be automatically played. It should be noted that the aforementioned predetermined time may be described in playback information (a playlist) stipulating a playback mode. Furthermore, in a case where there are a plurality of items of media data to be playback targets, the aforementioned playback control unit (38) may play the plurality of items of media data sequentially, or may play the plurality of items of media data simultaneously.

Furthermore, in a case where items of media data are to be played simultaneously, the items of media data may be displayed in a parallel manner or may be displayed in a superimposed manner.

### Example 2 of Playback Information

Furthermore, playback information such as that depicted in FIG. 12 may be used. FIG. 12 is a drawing depicting another example of playback information stipulating a playback mode for two items of media data. Hereinafter, a playback mode for two items of media data for which the playback device 3 refers to the playback information of (a) of FIG. 12 will be specifically described.

The playback control unit 38 having acquired the playback information of (a) of FIG. 12 from the data acquisition unit 36, first, plays a portion (partial video) captured in a first period designated by the playback information, of the first item of media data.

Specifically, the playback control unit 38 plays a partial video captured in a period that starts at the time t1 indicated by the attribute value of the start_time attribute of the first video tag corresponding to the first item of media data, and has the length d1 indicated by the attribute value of the duration attribute of the first video tag.

When playback of the partial video relating to the first item of media data has been completed, the playback control unit 38 plays a portion (partial video) captured in a second period designated by the playback information, of a video image represented by the second item of media data.

Specifically, the playback control unit 38 plays a partial video captured in a period that starts at a time indicated by an attribute value t2 of the start_time attribute of the second video tag corresponding to the second item of media data, and has the length d2 indicated by the attribute value of the duration attribute of the second video tag.

Next, a playback mode for two items of media data for which the playback device 3 refers to the playback information of (b) of FIG. 12 will be specifically described. The playback control unit 38 having acquired the playback information of (b) of FIG. 12 from the data acquisition unit 36 plays a portion (partial video) captured in a first period designated by the playback information, of the first item of media data. The playback control unit 38 plays a portion (partial video) captured in a second period designated by the playback information, of the second item of media data, in parallel with the playback of the partial video relating to the first item of media data.

Here, the first period is a period having the length d1 indicated by the attribute value of the duration attribute of the par tag, starting at the time t1 indicated by the attribute value of the start_time attribute of the first video tag corresponding to the first item of media data. Furthermore, the second period is a period having the length d2 indicated by the attribute value of the duration attribute of the par tag, starting at the time t2 indicated by the attribute value of the start_time attribute of the second video tag corresponding to the second item of media data.

Specifically, the playback control unit 38, with the display region being divided into two, displays the partial video of the first item of media data in one region, and, at the same time, displays the partial video of the second item of media data in the other region.

Following on, a playback mode for two items of media data for which the playback device 3 refers to the playback information of (c) of FIG. 12 will be specifically described. The playback control unit 38 having acquired the playback information of (c) of FIG. 12 plays a portion (partial video) captured in a specific period (the aforementioned period indicated by the start_time attribute of the video tag and the duration attribute of the par tag) designated by the playback information, of each of the two items of media data. Similar to the example of FIG. 11, in this playback information, the attribute value of synthe is “true”, and these partial videos are therefore displayed in a superimposed manner.

### Example 3 of Playback Information

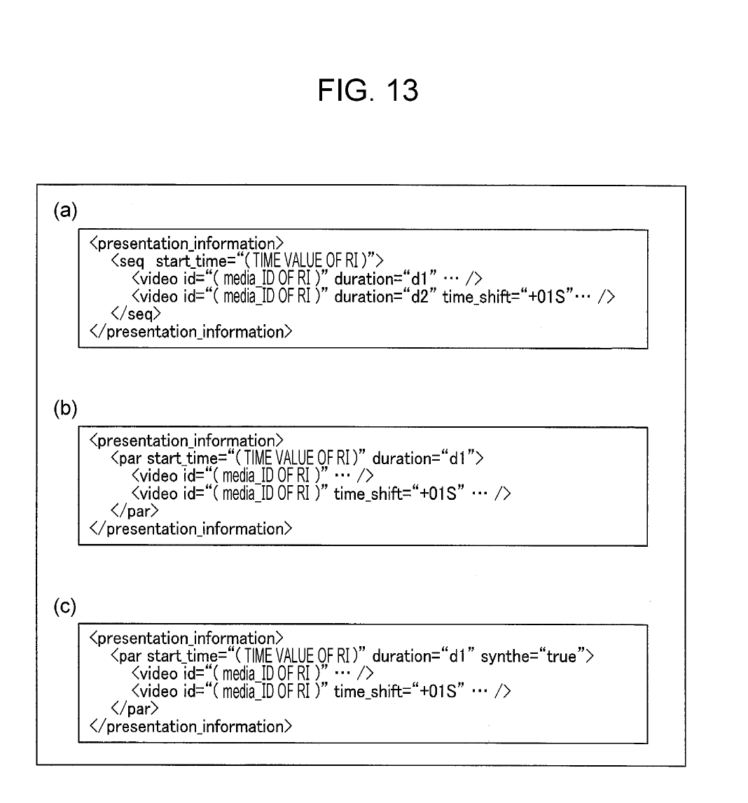

Furthermore, playback information such as that depicted in FIG. 13 may be used. FIG. 13 is a drawing depicting an example of playback information that includes information regarding a time shift. The playback information of FIG. 13 is information obtained by time shift information (a time_shift attribute) being included in the playback information of FIG. 11. Here, the time shift information is information indicating the size of a shift from a playback start position that has already been previously designated, in the playback start position of media data (video image) corresponding to the video tag including the time shift information.

The playback control unit 38 having acquired the playback information of (a) of FIG. 13, first, plays a portion (partial video) captured in a first period designated by the playback information, of the first item of media data, similar to the case where the playback information of (a) of FIG. 11 is acquired.

Next, when playback of the partial video has been completed, the playback control unit 38 plays a portion (partial video) captured in a second period designated by the playback information, of the second item of media data (media data in which the attribute value of video id is “(mediaID of RI)”). This partial video, in more detail, is a partial video captured in a period having the length d2 indicated by the attribute value of the duration attribute of the video tag, starting at a time obtained by adding the playback time “d1” of the first item of media data, and additionally adding the attribute value “+01S” (plus 1 second) of the attribute time_shift, to the attribute value “(time value of RI)” of the attribute start_time.

In (b) of FIG. 13, the seq tag of (a) of the same drawing has changed to a par tag, and two partial videos are thereby displayed simultaneously in a parallel manner. Furthermore, the playback information of (c) of the same drawing is information in which the synthe attribute value “true” has been added to the playback information of (b) of the same drawing, and two partial videos are thereby displayed simultaneously in a superimposed manner.

The playback information of (b) of the same drawing can be used to compare videos having different times, of the same media data, for example. For example, the media ID of one item of media data obtained by photographing a horse race may be described in both of two video tags in the playback information of (b) of the same drawing. In this case, videos of the same race are displayed in a parallel manner; however, one video becomes a video in which the time is shifted by an amount proportionate to the time_shift attribute value with respect to the other video. Thus, for example, in a case where it has not been possible to confirm in one video which horse won in a close contest, it is possible to once again confirm the finishing line scene by merely shifting attention to the other video, without carrying out an operation such as playback control.

The playback information of (c) of the same drawing is also similar, and can be used to compare videos having different times, of the same media data. In the playback information of (c) of the same drawing, two videos are displayed in a superimposed manner, and it is therefore possible to have the viewing user easily recognize the extent to which the positions of an object are different due to a time difference. For example, it is possible to also have the viewing user also easily recognize differences in the courses taken by each vehicle in a video of a car race or the like.

As mentioned above, a playback device (3) of the present invention is characterized in being provided with a playback control unit (38) that sets, as a playback target, media data having added thereto resource information that includes time information regarding a time that has shifted by a predetermined shift time from a predetermined time, from among a plurality of items of media data having added thereto resource information that includes time information indicating that photographing has been started at a predetermined time or photographing has been carried out at a predetermined time. Thus, from among a plurality of items of media data, media data that has been captured or has started to be captured at a time shifted from a predetermined time can be automatically played. It should be noted that the aforementioned predetermined time may be described in playback information (a playlist) stipulating a playback mode.

Furthermore, the aforementioned playback control unit (38) may sequentially play single items of media data from mutually shifted times, or may simultaneously play single items of media data. Furthermore, in a case where items of media data are to be played simultaneously, the items of media data may be displayed in a parallel manner or may be displayed in a superimposed manner.

### Example 4 of Playback Information

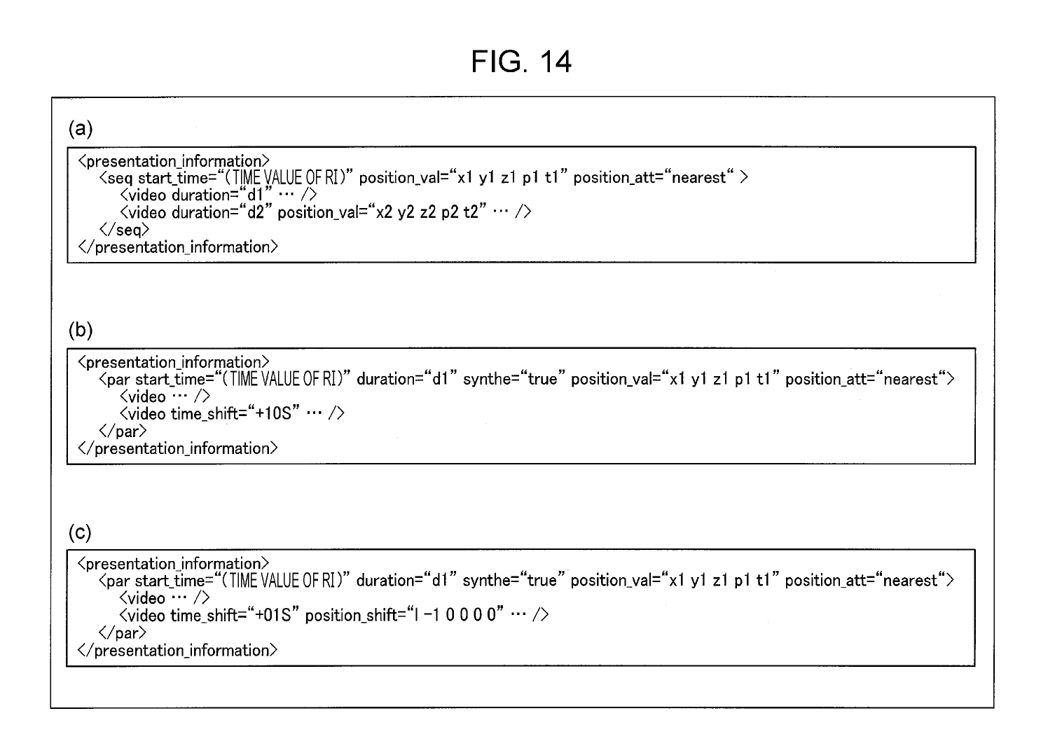

Furthermore, playback information such as that depicted in FIG. 14 may be used. FIG. 14 depicts playback information in which playback-target media data is designated by position designation information (a position_val attribute and a position_att attribute). Here, the position designation information is information designating where a captured video is to be played.

The attribute value of the position_val attribute indicates a photographing position and photographing direction. In the depicted example, the value of the position_val attribute is “x1 y1 z1 p1 t1”. The value of the position_val attribute is used for comparison with position information included in the resource information, and it is preferable therefore that the value of the position_val attribute have the same format as the position information and direction information included in the resource information. In the present example, in accordance with the format of the position information and direction information of (b) of FIG. 6, a value is used in which the position (x1, y1, z1) in a space defined by three axes, an angle in the horizontal direction (p1), and an elevation angle or inclination angle (t1) are sequentially arranged side-by-side.

The value of the position_att attribute specifies the way in which the position indicated by the value of the position_val attribute is to be used to specify media data. In the depicted example, the attribute value of the position_att attribute is “nearest”. This attribute value designates that the video having the position and photographing direction that are the most proximate to the position and photographing direction of the position_val attribute is to be a playback target. In each example hereinafter, an example is described in which position information and direction information based on the photographing device 1, namely the photographing position and photographing direction, are designated by the position_val attribute; however, it should be noted that position information and direction information based on an object, namely the position and direction of an object, may be designated.

It should be noted that there is a possibility that the photographing position of media data selected according to “nearest” may have shifted from the position indicated by the position_val attribute. Therefore, when media data selected according to “nearest” is to be displayed, image processing such as zooming and panning may be carried out for it to be made difficult for the user to perceive the aforementioned shift.

In a case where media data is to be played with reference to this playback information, the playback control unit 38, first, refers to the resource information of each item of media data acquired, to specify resource information designated by the aforementioned position designation information. Media data having the specified resource information associated therewith is then specified as a first playback target. Specifically, the playback control unit 38 specifies media data having associated therewith resource information that includes position information that is the nearest to the value “x1 y1 z1 p1 t1” from among the acquired media data, as a playback target. It should be noted that the position information may be position information regarding a photographing position or may be position information regarding an object.

Next, the playback control unit 38 specifies media data to be played following on from the aforementioned media data. Specifically, the playback control unit 38 specifies media data having associated therewith resource information that includes position information that is the nearest to the value “x2 y2 z2 p2 t2” from among the acquired media data, as a playback target. In the depicted example, the position_att attribute is not included in the second video tag; however, it should be noted that the position_att attribute is included in the higher-level seq tag. Therefore, the higher-level attribute value is inherited and therefore the attribute value “nearest” that is the same as the position_att attribute of the first (higher-level) video tag is applied also to the second video tag. It should be noted that, in a case where a position_att attribute having an attribute value that is different from the higher-level tag is included in a lower-level tag, the attribute value thereof is applied (the higher-level attribute value is not inherited in this case). The processing after the two items of playback-target media data have been specified is similar to that of the example of FIG. 11 or the like, and partial videos of each item of media data are sequentially played.

The playback information of (b) of FIG. 14, compared to the playback information of (a) of the same drawing, is different in that the playback information is described with a par tag, in that the synthe attribute (attribute value is “true”) is described, and in that time shift information (attribute value is “+10S”) is described in the second video tag. In a case where this playback information is used, the first item of media data is specified in a manner similar to that of (a) of the same drawing. Meanwhile, similar to the first item of media data, the second item of media data is also specified as that being nearest to the position “x1 y1 z1 p1 t1”. However, in accordance with the time shift information, that being nearest to the position “x1 y1 z1 p1 t1” at 10 seconds (+10S) after a designated photographing time (start_time) is specified. These specified items of media data are then displayed simultaneously in a superimposed manner in accordance with the synthe attribute.

Furthermore, (c) of the same drawing depicts an example in which position shift information (a position_shift attribute) has been added to the second video tag of the playback information of (b) of the same drawing. By carrying out playback in accordance with this playback information, two videos having shifted times and positions are displayed in a superimposed manner. In this way, by shifting the time and position, it is possible to view a video in which photographing was carried out using the photographing device 1, for example, and a video in which the photographer of the aforementioned video has been captured by another photographer (a video captured in a period in which the aforementioned photographer was not photographing, and captured near to the aforementioned photographer). For example, it is possible to simultaneously confirm the scenery of a travel destination captured using the photographing device 1 by the photographer, and the state of the photographer and the surroundings thereof immediately before or immediately after that scenery was captured, and a memory of a trip can therefore be vividly revived.

In a case where this playback information is used, the first item of media data is specified in a manner similar to that of (a) of the same drawing. However, the second item of media data is specified as that being nearest to a position obtained by shifting the position “x1 y1 z1 p1 t1” according to the position_shift attribute. Furthermore, since time shift information is also included, that being nearest to the aforementioned shifted position at 1 second (+01S) from a designated photographing time (start_time) is specified. These specified items of media data are then displayed simultaneously in a superimposed manner in accordance with the synthe attribute.

Here, the attribute value of the position_shift attribute can be described with either format of a local designation format (a format in which the attribute value is expressed by “1 sx1 sy1 sz1 sp1 st1”) and a global designation format (a format in which the attribute value is expressed by “g sx1 sy1 sz1 sp1 st1”). It should be noted that the first parameter “1” indicates the local designation format, and the first parameter “g” indicates the global designation format.

The position_shift attribute described using the local designation format stipulates the shift direction on the basis of direction information (facing_direction) included in the resource information. In more detail, the position_shift attribute indicates a shift amount and a shift direction according to a vector (sx1, sy1, sz1) in a coordinate space of a local coordinate system, in which a direction indicated by the direction information included in the resource information added to the first item of media data, namely the photographing direction, is taken as the x axis positive direction, the upward vertical direction is taken as the z axis positive direction, and an axis perpendicular to these axes is taken as the y axis (the positive direction of the y axis is the right side or the left side toward the photographing direction).

The attribute value of the position_shift attribute of (c) of FIG. 14 is described in the local designation format, whereas the position_val attribute is indicated by coordinate values of the global coordinate system. Therefore, for example, (x1, y1, z1) of the position_val attribute is converted into the local designation format or the like, for the position to be shifted with the coordinate systems having been made uniform. In the local designation format, a designation is produced in which shifting is carried out forward and backward, from the left after shifting 90 degrees, and from the right after shifting −90 degrees, with respect to a target (object).

However, the position_shift attribute described using the global designation format indicates a shift amount and a shift direction according to a vector (sx1, sy1, sz1) in a coordinate space of the global coordinate system that is the same as that of the position information included in the resource information. Therefore, in a case where the position_shift attribute described in the global designation format is used, a conversion such as the aforementioned is not required, and it is sufficient for the values of the axes thereof to be added to the values of the axes corresponding to the position_val attribute as they are.

The playback information of (c) of FIG. 14 includes both the time_shift attribute and the position_shift attribute; however, it should be noted that one of these may be included in the playback information. By playback information that includes the position_shift attribute from thereamong being applied in the display of a video in a car navigation device, for example, it also becomes possible for a video of an accident that has occurred ahead on a road to be displayed or the like. This is described hereinafter.

An example of a playback mode for two items of media data for which this kind of playback information is referred to by a playback device 3 corresponding to a car navigation device will be described hereinafter. The server 2 may be configured in such a way that, in a case where a site where a traffic accident has occurred is recognized, the aforementioned playback information (to be specific, playback information in which the time at which the site where the traffic accident occurred was recognized is indicated by the attribute value of the start_time attribute, and the site is indicated by the attribute value of the position_val attribute) is distributed to the playback device 3.

The playback control unit 38 of the playback device 3 having received the playback information may determine whether or not the site is located on a travel route, and, if having determined that the site is located on the travel route, may calculate a vector such as that given hereinafter in the global coordinate system. In other words, the playback control unit 38 may calculate a vector in which the site is taken as a start point coordinate, and another site (a site near to the device itself by a fixed distance along the travel route from the site where the traffic accident occurred) on the travel is taken as an end point coordinate.

The playback control unit 38 may then update the attribute value of the position_shift attribute of the second video tag in the playback information to a value such as one indicating the aforementioned vector (a value described in the global designation format), and may display two videos on the basis of the updated playback information. It should be noted that the playback control unit 38 may display a video indicating the state of the accident scene, and a video indicating the degree of accident congestion at another site on the travel route. It is thereby possible for the user of the playback device 3 to be prompted to avoid becoming involved in an accident or congestion. Furthermore, only the state of the accident scene may be displayed.

### [Additional Items Relating to Position Designation Information]

As the attribute value of the position_att attribute, “nearest_cond” and “strict” may be given other than “nearest”.

The “strict” attribute value designates that a video captured in a position and photographing direction indicated by the position_val attribute is to be a playback target. In a case where the “strict” attribute value is described, display is not carried out if there is no media data having added thereto resource information of a position and photographing direction that match the position and photographing direction indicated by the position_val attribute. The default attribute value may be “strict”.

The “nearest_cond bx by bz bp bt” (“bx”, “by”, “bz”, “bp”, and “bt” correspond to position information and direction information, and have numerical values of 0 or 1) attribute value, similar to “nearest”, designates that the video having the position that is the most proximate to the position of the position_val attribute is to be a playback target. However, a video having matching position information or direction information for which the value is “0” is to be a playback target. For example, the “nearest_cond 1 1 1 0 0” attribute value designates a video having a matching direction and a position that is the nearest to the designated value, as a playback target, and the “nearest_cond 0 0 0 1 1” attribute value designates a video having a matching position and a direction that is the nearest to the designated value, as a playback target. It should be noted that the values of bx, by, bz, bp, and bt are not restricted to 0 or 1, and may be values indicating a degree of proximity, for example. For instance, a configuration may be implemented in such a way that it is possible for bx, by, bz, bp, and bt to describe values from 0 to 100 and the degree of proximity is weighted and determined. In this case, 0 represents a match, and 100 represents the greatest permitted deviation.

Furthermore, the following, for example, are feasible as other examples of attribute values for position_att. “strict_proc”: designates that a video having the position that is the most proximate to the position of the position_val attribute is to be processed (for example, image processing such as pan processing and/or zoom processing), for a video having the position of the position_val attribute to be generated and displayed.

“strict_synth”: designates that a video having the position of the position_val attribute is to be synthesized from one or more videos having the position that is the most proximate to the position of the position_val attribute and displayed.

“strict_synth_num num” (“num” at the end having a numerical value that indicates a quantity): an attribute value obtained by adding “num”, which designates the number of synthesis-target videos, to “strict_synth”. This attribute value designates that a video having the position of the position_val attribute is to be synthesized from “num” quantity of videos selected in order of nearness to the position of the position_val attribute, and displayed.

“strict_synth_dis dis” (“dis” at the end having a numerical value that indicates a distance): an attribute value obtained by adding “dis”, which designates the distance from the position of the position_val attribute to the position of a synthesis-target video, to “strict_synth”. This attribute value designates that a video having the position of the position_val attribute is to be synthesized from a video having a position within the range of the distance “dis” from the position of the position_val attribute, and displayed.

It should be noted that, in a case where the playback device 3 is not provided with a video synthesis function, a video may be processed with attribute values designating the synthesis of a video such as “strict_synth” being interpreted as “strict_proc”.

“nearest_dis dis” (“dis” at the end having a numerical value that indicates a distance): an attribute value obtained by adding “dis”, which designates the distance from the position of the position_val attribute, to “nearest”. This attribute value designates that the video having the position that is the nearest to the position of the position_val attribute, from among videos having a position within the range of the distance “dis” from the position of the position_val attribute, is to be displayed. A video that is displayed according to this attribute value may be subjected to image processing such as zooming or panning.

“best”: designates that an optimum video selected according to a separately designated standard, from among a plurality of videos that are proximate to the position of the position_val attribute, is to be displayed. This standard is not particularly restricted provided it is a standard with which a video is selected. For example, the SN ratio of a video, the SN ratio of audio, the position or size of an object within the angle of view of a video, or the like may serve as the aforementioned standard. From among these standards, the SN ratio of a video is suitable for selecting a video in which an object is vividly captured in, for example, a dark venue or the like. The SN ratio of audio can be applied in a case where the media data includes audio, and this is suitable for selecting media data that is easy to hear. Furthermore, the position or size of an object within the angle of view is suitable for selecting media data in which an object is fully and suitably contained within the angle of view (media data in which it is determined that the background region is the smallest and the object boundary does not touch the image edge).

“best_num num” (“num” at the end having a numerical value that indicates a quantity): an attribute value obtained by adding “num”, which designates the number of selection-candidate videos, to “best”. This attribute value designates that an optimum video selected using the aforementioned standard is to be displayed, from “num” quantity of videos selected in order of nearness to the position of the position_val attribute.

“best_dis dis” (“dis” at the end having a numerical value that indicates a distance): an attribute value obtained by adding “dis”, which designates the distance from the position of the position_val attribute, to “best”. This attribute value designates that an optimum video selected using the aforementioned standard is to be displayed, from videos in positions within the range of “dis” from the position of the position_val attribute.

It should be noted that, in an attribute value such as “best”, in a case where the aforementioned standard is not indicated, or if the indicated standard is not suitable, the playback device 3 may select a video with the attribute value in question being interpreted as “nearest”.

### [Advantage of Playing a Video of a Nearby Position That Does Not Strictly Match a Designated Position]

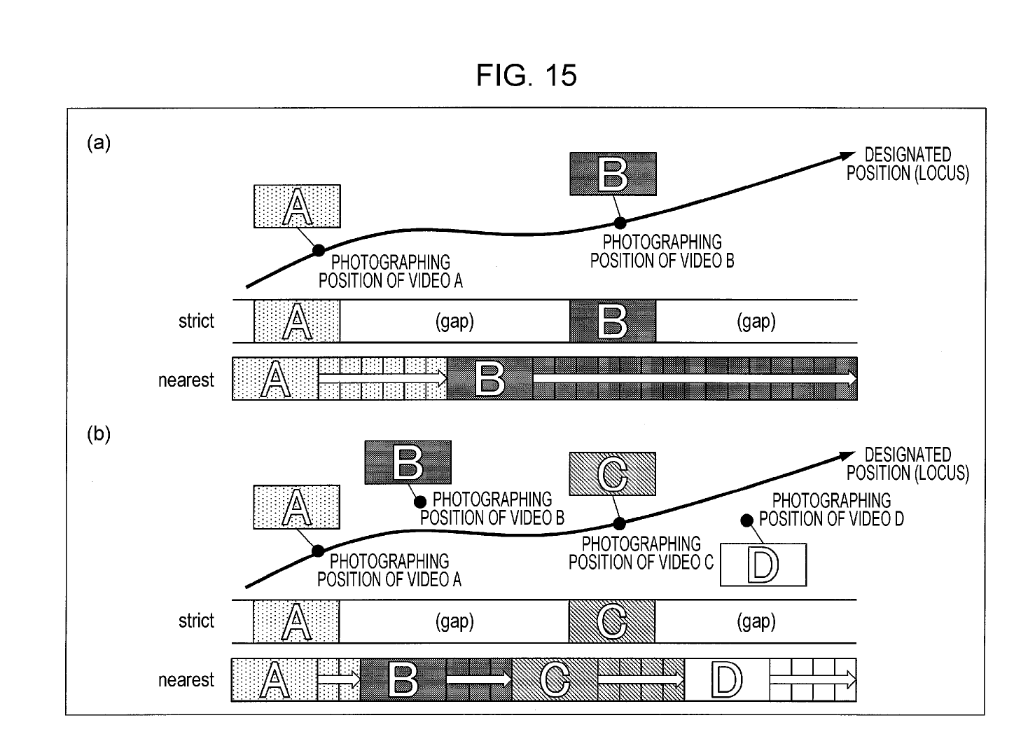

An advantage of playing a video of a nearby position that does not strictly match a designated position will be described based on FIG. 15. FIG. 15 is a drawing describing an advantage of playing a video of a nearby position that does not strictly match a designated position.

An example in which a video that has been captured at a designated position while that designated position is moved is depicted in FIG. 15. That is, in the present example, the playback control unit 38 of the playback device 3 receives the designation of a position performed by a user operation or the like, specifies media data having associated therewith resource information that includes position information of the designated position, as a playback target, and plays the media data. Thus, items of media data having different photographing positions are sequentially played. That is, a street view implemented by using video images becomes possible. It should be noted that it may be possible for a position to be designated by displaying an image of a map, for example, and selecting a site on the map.

This kind of street view is effective for conveying the state of an event such as a festival, for example. At this kind of event, a large quantity of media data is generated, which becomes material for a street view. For example, the media data of videos captured by photographing devices 1 (for example, a smartphone) of users participating in the event, and videos captured by photographing devices 1 (a fixed camera, a stage camera, a camera attached to a float, a wearable camera attached to a performer, a drone camera, or the like) prepared by the event organizer are collected in the server 2 (cloud).

In the example of (a) of the same drawing, a designated position first passes through the photographing position of video A and then passes through the photographing position of video B. In this case, if (strict) media data in which the designated position and the photographing position strictly match is set as a playback target, video A is displayed when the designated position matches the photographing position of the video A; however, when having moved away from that photographing position, a state (gap) is entered in which a video is not displayed. Then, video B is displayed when the designated position matches the photographing position of video B; however, when having moved away from that photographing position, a state (gap) is once again entered in which a video is not displayed.

However, if the (nearest) media data having the photographing position that is the nearest to the designated position is set as a playback target, video A is displayed in a period in which the photographing position that is the nearest from the designated position is the photographing position of video A. Then, video B is displayed in a period in which the photographing position that is the nearest from the designated position has become the photographing position of video B. In this way, if the (nearest) media data having the photographing position that is the nearest to the designated position is set as a playback target, the period (gap) in which a video is not displayed can be eliminated.

Furthermore, in the example of (b) of the same drawing, the designated position passes through the photographing position of video A, then passes through the vicinity of the photographing position of video B, next passes through the photographing position of video C, and finally passes through the vicinity of the photographing position of video D. In this case, if (strict) media data in which the designated position and the photographing position strictly match is set as a playback target, video A and video C are displayed at timings when the photographing positions and the designated position match; however, video B and video D are not displayed since the photographing positions do not match the designated position. Furthermore, a video is not displayed in the period after video A has been displayed to video C being displayed, and in the period after video C has been displayed.

However, if the (nearest) media data having the photographing position that is the nearest to the designated position is set as a playback target, video B and video D in which the photographing positions do not match the designated position also become playback targets, and videos A to D are sequentially displayed without interruption. It is preferable that this kind of uninterrupted display is carried out when a video street view is to be displayed, and therefore at such time it is preferable that the (nearest) media data having the photographing position that is the nearest to the designated position be set as a playback target.

As mentioned above, a playback device (3) of the present invention is characterized in being provided with a playback control unit (38) that sets, as a playback target, media data having added thereto resource information that includes predetermined position information, from among a plurality of items of media data having added thereto resource information that includes position information indicating a photographing position or a position of a captured object. Thus, media data extracted based on position information from among a plurality of items of media data can be automatically played. It should be noted that the aforementioned predetermined position information may be described in playback information (a playlist) stipulating a playback mode.

Furthermore, in a case where there are a plurality of items of media data to be playback targets, the aforementioned playback control unit (38) may play the plurality of items of media data sequentially, or may play the plurality of items of media data simultaneously. Furthermore, in a case where items of media data are to be played simultaneously, the items of media data may be displayed in a parallel manner or may be displayed in a superimposed manner.

Furthermore, the playback control unit (38) may set, as a playback target, media data having added thereto resource information that includes position information indicating the position that is the nearest to a predetermined position, in a case where there is no media data having added thereto resource information in which the position indicated by position information matches the predetermined position, among the aforementioned plurality of items of media data.

### Example 5 of Playback Information

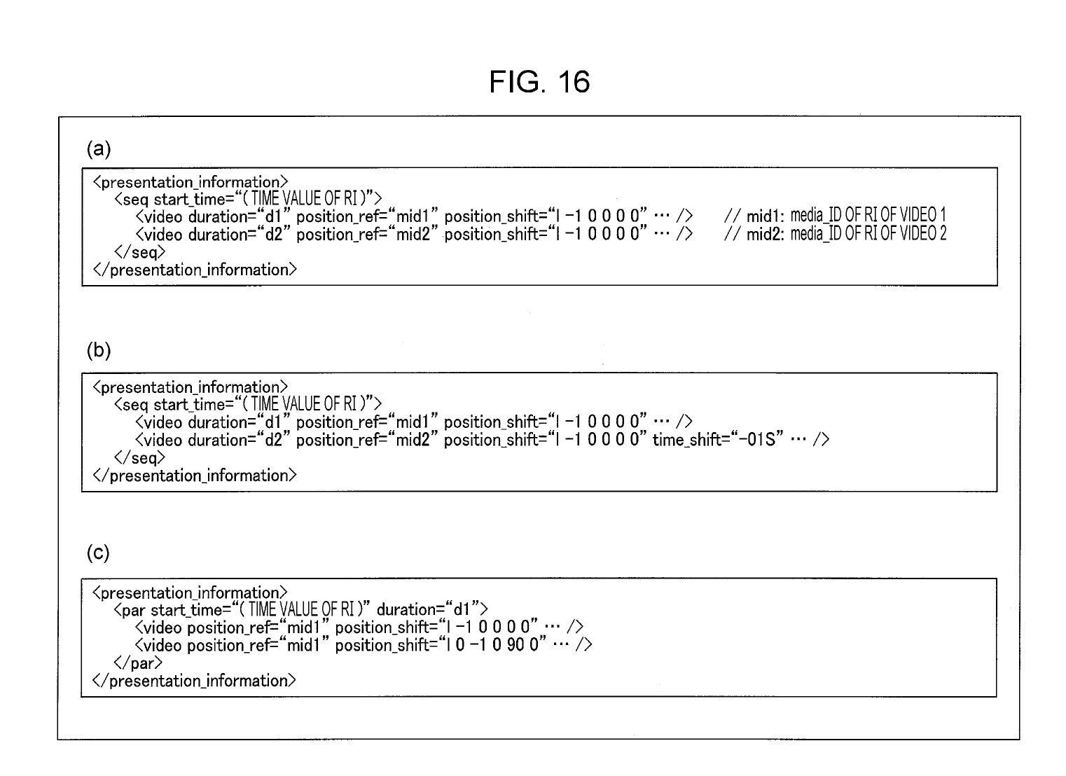

Hereinafter, a playback mode for two items of media data for which reference is made to yet another form of playback information will be described with reference to FIG. 16. Playback information in which playback-target media data is designated by position designation information (a position_ref attribute and the position_shift attribute) rather than a media ID is depicted in (a) to (c) of FIG. 16. In this playback information, a video captured at a position that has been separated (shifted) in a predetermined direction from a certain photographing position (a photographing position of media data specified by a media ID) is set as a playback target.

In FIG. 16, the attribute value of the position_ref attribute is a media ID. Resource information is added to media data identified by this media ID, and position information is included in the resource information. Therefore, media data is specified from the media ID described in the attribute value of position_ref, reference is made to resource information of the specified media ID, and position information can thereby be specified. Furthermore, the depicted playback information includes the position_shift attribute. That is, the depicted playback information indicates that the playback target is media data of a position obtained by the position indicated by position information specified using the media ID having been shifted according to the position_shift attribute.

In the playback device 3, which carries out playback using this playback information ((a) of FIG. 16), the playback control unit 38 refers to the resource information of media data in which the media ID is mid1, and thereby specifies the photographing position and photographing direction of that media data. It should be noted that this photographing position and photographing direction are the photographing position and photographing direction at a time indicated by the attribute value of the start_time attribute.

Next, the playback control unit 38 causes the specified photographing position and photographing direction to be shifted according to the position_shift attribute. The playback control unit 38 then refers to each item of resource information of playable media data, to specify a video having the shifted photographing position and photographing direction as a playback target. Following on, the playback control unit 38, in a similar manner also for the second video tag, specifies the photographing position and photographing direction of media data in which the media ID is mid2, causes these to be shifted, and specifies a video having the shifted photographing position and photographing direction as a playback target. It should be noted that the processing from after the playback target has been specified is as previously mentioned, and therefore a description thereof is omitted here.

Furthermore, the playback information of (b) of the same drawing is different compared to the playback information of (a) of the same drawing in that the time_shift attribute is included in the second video tag. In a case where playback is to be carried out using the playback information of (b) of the same drawing, the specifying of the first item of media data is similar to the aforementioned. However, for the second item of media data, this is similar to the aforementioned up to the photographing position and photographing direction of media data in which the media ID is mid2 being specified and being shifted according to the position_shift attribute. In a case where the playback information of (b) of the same drawing is to be used, thereafter, the time is shifted according to the time_shift attribute, and a video having the shifted time, photographing position, and photographing direction is specified as a playback target.

Furthermore, the playback information of (c) of the same drawing is different compared to the playback information of (a) of the same drawing in that, in the second video tag, the media ID “mid1”, which is the same as that of the second video tag, is described in the position_shift attribute. Furthermore, the value of the position_shift attribute of the second video tag is different from that in the playback information of (a) of the same drawing. There is also a difference in that the seq tag changed to a par tag.

In a case where playback is to be carried out using the playback information of (c) of the same drawing, the specifying of the first item of media data is similar to the aforementioned. However, for the second item of media data, the photographing position and photographing direction of media data in which the media ID is mid1 is specified, and this is shifted according to the position_shift attribute. Specifically, the photographing position is shifted −1 in the y axis direction, and the photographing direction (angle in the horizontal direction) is shifted 90 degrees. A video having the shifted photographing position and photographing direction is then specified as a playback target. A video specified in this way becomes a video in which the object has been captured from the side. Thus, by playing this simultaneously in parallel with the media data indicated by the first video tag, videos in which one object has been captured from two different angles can be presented to the viewing user at the same time.

As mentioned above, a playback device (3) of the present invention is characterized in being provided with a playback control unit (38) that sets, as a playback target, media data having added thereto resource information that includes position information of a position that has been shifted by a predetermined shift amount from a predetermined position, from among a plurality of items of media data having added thereto resource information that includes position information indicating a photographing position or a position of a captured object. Thus, from among a plurality of items of media data, media data captured in the surroundings of a predetermined position, or in which an object in the surroundings of a predetermined object has been captured, can be automatically played. It should be noted that the aforementioned predetermined position information may be described in playback information (a playlist) stipulating a playback mode.

### Example 6 of Playback Information

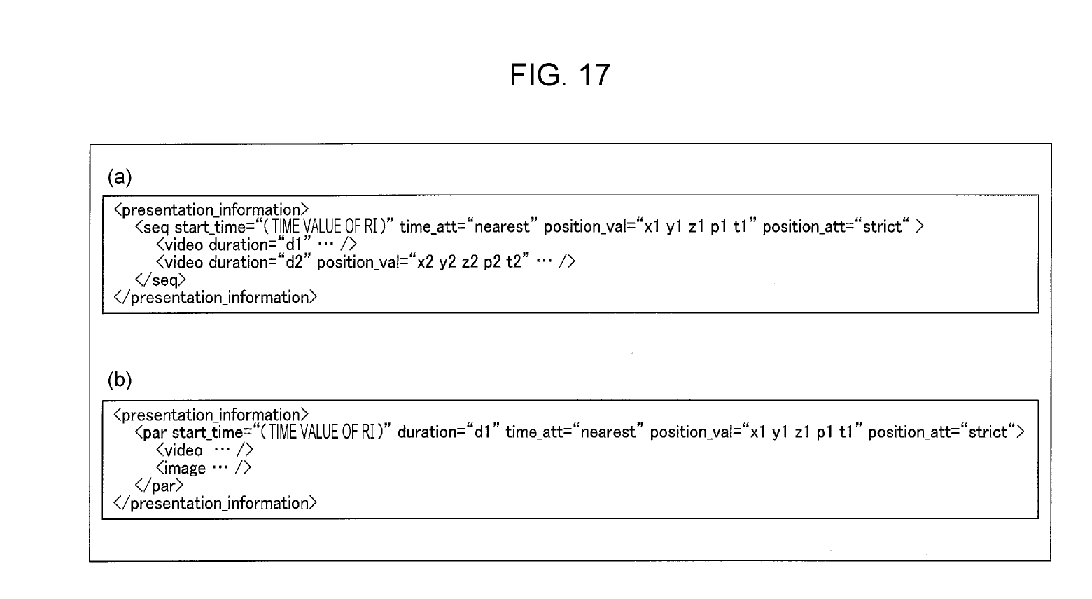

Hereinafter, a playback mode for two items of media data for which reference is made to yet another form of playback information will be described with reference to FIG. 17. The present playback information includes a time_att attribute in addition to the start_time attribute. The time_att attribute designates the way in which the start_time attribute is to be used to specify media data. An attribute value similar to that of the position_att attribute can be applied as an attribute value of the time_att attribute. For example, “nearest” is described in the depicted example.

In the playback device 3, which carries out playback using the playback information of (a) of the same drawing, the playback control unit 38 specifies media data designated by the attribute values of the position_val attribute and the position_att attribute. That is, media data that has been strictly captured in the position and photographing direction of {x1, y1, z1, p1, t1} is specified. The playback control unit 38 then specifies the media data in which the photographing time is the nearest to the value of the start_time attribute, as a playback target from among the specified media data, and carries out playback for the period “d1” indicated by the duration attribute.

Next, the playback control unit 38 refers to the second video tag, and specifies media data captured in the position and photographing direction of {x2, y2, z2, p2, t2}. It should be noted that the second video tag inherits the “strict” attribute value of the position_att attribute of the higher-level seq tag, and therefore specifies media data in which the position and photographing direction completely match.

Furthermore, the second video tag also inherits the “nearest” attribute value of the time_att attribute of the higher-level seq tag. Therefore, the playback control unit 38 specifies the media data in which the photographing time is the nearest to (time value of RI)+d1, as a playback target from among the specified media data, and carries out playback for the period “d2” indicated by the duration attribute.

Meanwhile, the playback information of (b) of the same drawing stipulates by the par tag that two items of media data are to be played in a parallel manner. One item of data that is to be played in a parallel manner is a video image and is described with a video tag. Furthermore, the other item of data that is to be played in a parallel manner is a still image and is described with an image tag.

Similar to the playback information of (a) of the same drawing, the time_att attribute having an attribute value of “nearest” is also described in this playback information. Consequently, in the playback device 3, which carries out playback using the playback information of (b) of the same drawing, the playback control unit 38 specifies media data designated by the attribute values of the position_val attribute and the position_att attribute. That is, media data (still image and video image) that has been strictly captured in the position and photographing direction of {x1, y1, z1, p1, t1} is specified. Then, from among the specified media data, the media data of a still image for which the photographing time is the nearest to the value of the start_time attribute (if there is a still image having the designated photographing time, the still image), and the media data of a video image for which the photographing time is the nearest to the value of the start_time attribute (if there is a video image that includes the designated photographing time, the video image, or if there is no video image that includes the designated photographing time, the video image having the photographing time that is the nearest to the designated photographing time) are specified as playback targets, these are played for the period “d1” indicated by the duration attribute, and are displayed side-by-side.

As mentioned above, a playback device (3) of the present invention is provided with a playback control unit (38) that sets, as a playback target, media data having added thereto resource information that includes time information indicating that photographing has been started at a predetermined time or photographing has been carried out at a predetermined time, from among a plurality of items of media data having added thereto resource information, and the playback control unit (38), in a case where there is no media data having added thereto resource information in which the time indicated by the time information matches the predetermined time, within the plurality of items of media data, sets, as a playback target, media data having added thereto resource information that includes the time information indicating the time that is the nearest to the predetermined time.

### Example 7 of Playback Information

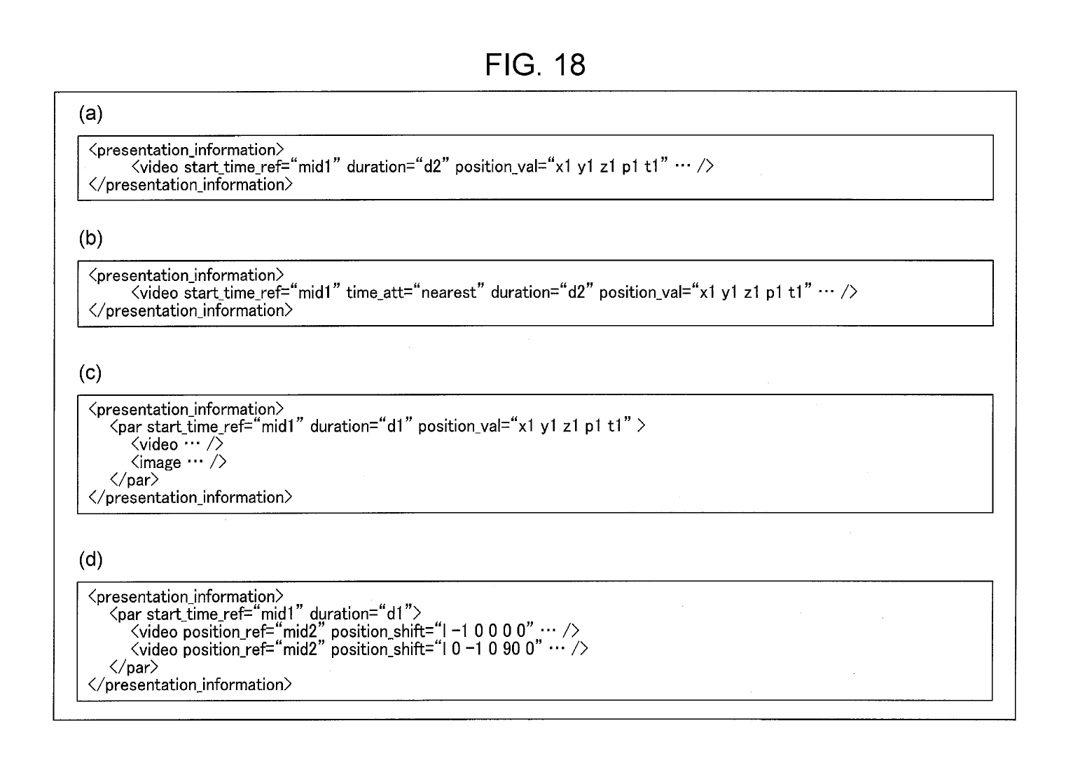

Hereinafter, a playback mode for media data for which reference is made to yet another form of playback information will be described with reference to FIG. 18. In the position designation information of FIG. 18, the photographing start time (the photographing time in a case where the media data is a still image) of media data to be a playback target is designated by using the media ID. Specifically, in the playback information of the same drawing, time designation information (a start_time_ref attribute) is described, and a media ID is described as the attribute value thereof.

In the playback device 3, which carries out playback using the playback information of (a) of the same drawing, the playback control unit 38 refers to the resource information of media data in which the media ID is mid1, and thereby specifies the photographing start time (the photographing time in a case where the media data is a still image) of that media data. The specified time is then set as the photographing start time, and media data in which the position and photographing direction at that time match the position and photographing direction indicated by the position_val attribute is set as a playback target. This media data is then played for the period “d2” indicated by the duration attribute. It should be noted that, in the example of the same drawing, the position_att attribute is not described, and therefore, when the aforementioned playback target is specified, the specifying is carried out with “strict”, which is the default application example, being applied.

Furthermore, in the playback information of (b) of the same drawing, there is a difference compared to the playback information of (a) of the same drawing in that the time_att attribute in which the attribute value is “nearest” has been added. Therefore, in a case where playback is to be carried out using the playback information of (b) of the same drawing, from among media data matching the position and photographing direction indicated by the position_val attribute, the media data having the photographing time that is the nearest to the photographing start time or the photographing time of the media data in which the media ID is mid1 is played for the period “d2”.

Furthermore, the playback information of (c) of the same drawing is described using the par tag. In a case where playback is to be carried out using this playback information, media data matching the position and photographing direction indicated by the position_val attribute, and having the photographing time that is the nearest to the photographing start time or the photographing time of the media data in which the media ID is mid1 is specified as a playback target. It should be noted that, since a video tag and an image tag are both included in the par tag, video image media data and still image media data are each taken as one playback target. The two items of media data set as playback targets are then simultaneously played for the period “d1”, and are displayed in a parallel manner. However, the playback control unit 38 may set media data having a media ID that is the attribute value of the start_time_ref attribute (mid1 in this example) as being excluded from the playback targets.

It should be noted that, as mentioned above, a position can also be designated by the position_ref attribute instead of a position being designated by the position_val attribute, and this designation of a position can be jointly used with a designation of a time by using the start_time_ref attribute. Furthermore, in a case where these are jointly used, as in the playback information of (d) of the same drawing, for example, respectively separate media IDs may be designated by the position_ref attribute and the start_time_ref attribute.

In the playback device 3, which carries out playback using the playback information of (d) of the same drawing, the playback control unit 38 specifies the photographing start time (or photographing time) with reference being made to the resource information of media data having the media ID (mid1) described in the start_time_ref attribute. Furthermore, the playback control unit 38 specifies the photographing position and photographing direction with reference being made to the resource information of media data having the media ID (mid2) described in the position_ref attribute. The specified photographing position and photographing direction are then shifted according to the position_shift attribute. Specifically, shifting is carried out by “1−1 0 0 0 0 for the first video tag”, and shifting is carried out by “1 0−1 0 90 0” for the second video tag. Items of media data having the specified photographing start time (or photographing time) and the shifted photographing position and photographing direction are then respectively specified as playback targets, and these are played for the period “d1” and are displayed in a parallel manner.

### Embodiment 2

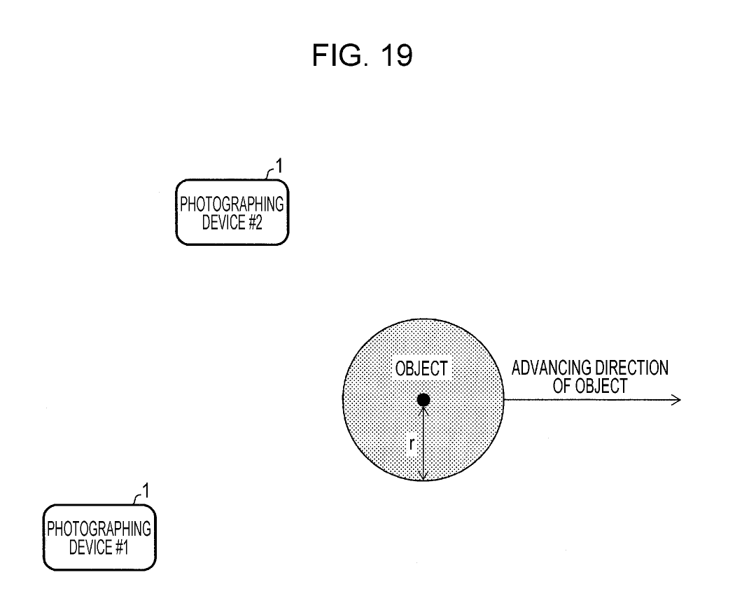

Hereinafter, embodiment 2 of the present invention will be described in detail on the basis of FIGS. 19 to 25. A media-related information generation system 101 in the present embodiment presents a video in which an object serves as the viewpoint (a video in which an object has been captured from directly behind).

### [Additional Items Relating to Resource Information]

The “front of an object” indicated by direction information (facing_direction) included in resource information is taken as the direction in which a face is directed in a case where the object has a face as with a person or animal, and is taken as the advancing direction in a case where the object does not have a face as with a ball or the like. It should be noted that, in a case where the direction in which a face is directed and the advancing direction are different as with a crab, either of these may be taken as being the front.

Furthermore, a configuration is implemented in which size information (object_occupancy) that indicates the size of the object is included in the resource information, in addition to the position information and direction information of an object. For example, the radius of an object in a case where the object is a sphere, or polygon information (vertex coordinate information of each polygon representing an object) in a case where the object is a cylinder, a cube, a stick figure model, or the like, may be given as size information.

The size information may be calculated by the target information acquisition unit 17 of the photographing device 1, or may be calculated by the data acquisition unit 25 of the server 2. It is possible for the size information to be calculated based on the distance from the photographing device 1 to an object, the photographing magnification, and the size of an object in a captured image.

Furthermore, the photographing device 1 or the server 2 may retain information indicating, for each type of object, the average size of object for that type. In a case where the type of object has been recognized, the photographing device 1 or the server 2 may refer to this information to specify the average size of the object in question, and include size information indicating the specified size in resource information.

FIG. 19 is a drawing describing a portion of an overview of the media-related information generation system 101. In the media-related information generation system 101 depicted in FIG. 19, the object is a moving ball. In this case, direction information of an object is information indicating the advancing direction of the ball, and size information of an object is information indicating the ball radius.

### [Example of Resource Information (Still Image)]

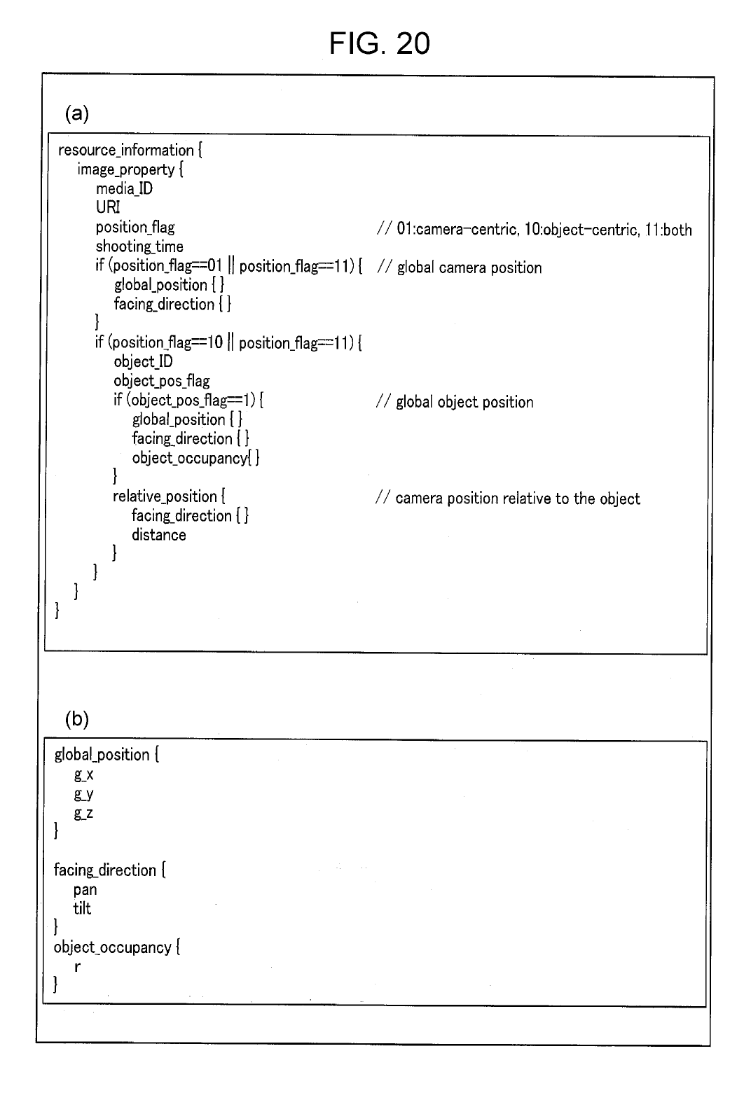

Next, an example of the resource information will be described based on FIG. 20. FIG. 20 is a drawing depicting an example of syntax for resource information for a still image. The resource information according to the syntax depicted in (a) of FIG. 20 has a configuration in which size information (object_occupancy) of an object has been added to the resource information depicted in FIG. 6. Furthermore, the size information of an object may be described in a format such as that depicted in (b) of FIG. 20. The size information (object_occupancy) of (b) of FIG. 20 is information indicating the radius (r) of an object.

### [Example of Resource Information (Video Image)]

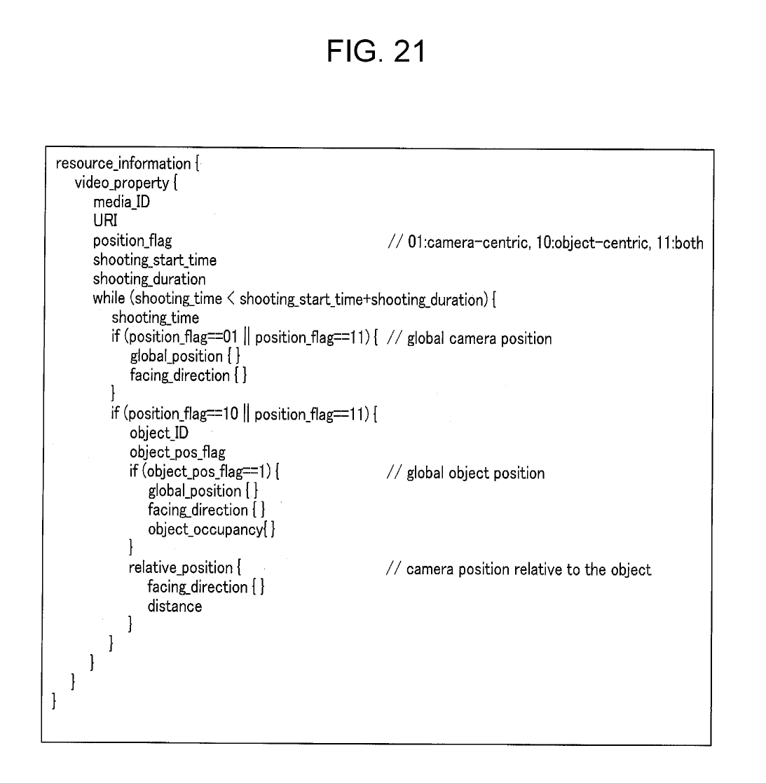

Following on, an example of resource information for a video image will be described based on FIG. 21. FIG. 21 is a drawing depicting an example of syntax for resource information for a video image. Similar to the aforementioned still image, the depicted resource information has a configuration in which size information (object_occupancy) of an object has been added to the resource information depicted in FIG. 7.

Furthermore, resource information that includes size information (object_occupancy) of an object in a video image may be generated in the photographing device 1 or may be generated in the server 2. There are many cases where the size of an object does not change as time elapses; however, the size of plants and animals and the like changes due to posture, and elastic bodies deform. Therefore, in a case where a video image has been captured, the photographing device 1 or the server 2 includes size information of an object at each predetermined continuation time in resource information. That is, while photographing is continuing, the photographing device 1 or the server 2 repeatedly (at each predetermined continuation time) executes processing for describing a combination of the photographing time and size information corresponding to that time in resource information.

Thus, a combination of the photographing time and size information corresponding to that time is repeatedly described at each predetermined continuation time in the resource information for a video image. It should be noted that, in the photographing device 1 or the server 2, the processing for describing the aforementioned combination in the resource information for a video image may be executed in a period manner or may be executed in a non-periodic manner. For example, the photographing device 1 or the server 2 may record a combination of size information and a detected time every time a change in the photographing position is detected, every time a change in the size of an object is detected, and/or every time it is detected that the photographing target has moved to another object.

Furthermore, in a case where resource information is generated in the server 2, a configuration may be implemented in which calculated size information of an object is added all at once in the RI information of a plurality of items of media data that include a common object.

### Example 1 of Playback Information

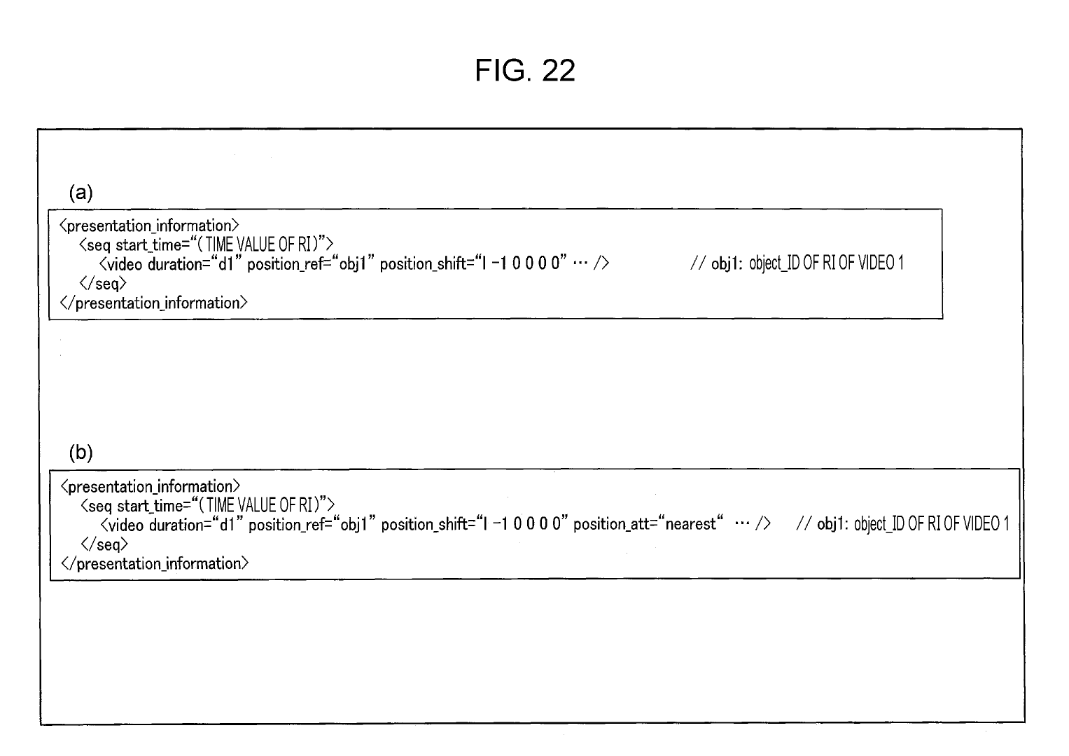

FIG. 22 is a drawing depicting an example of playback information stipulating a playback mode for media data. Specifically, the playback control unit 38 specifies media data by using an object ID (obj1) described in the attribute value of the position_ref attribute. The playback control unit 38 then refers to the resource information of the specified media data, and specifies the position information of an object. In addition, the playback control unit 38 specifies, as a playback target, media data captured by the imaging device 1, which is an imaging device 1 that is installed in a position that has been shifted according to the position_shift attribute (in the example depicted in (a) of FIG. 22, a position shifted by −1 in the X axis direction (in other words, by 1 in the opposite direction to the direction of the object)) from the specified position, and is facing the direction designated by the position_shift attribute. In the example depicted in (a) of FIG. 22, a video in which an object has been captured from directly behind can be presented to the viewing user.

Furthermore, the imaging device 1 or the server 2 may specify a plurality of items of media data in which an object (obj1) has been captured from directly behind, and may generate playback information in which a plurality of video tags corresponding to the plurality of items of media data in question are arranged side-by-side in order of the photographing start time of the object (in order of the time at which photographing of the object started). Each video tag of this playback information includes the photographing start time of the corresponding media data as the value of the start_time attribute, and includes the value of the time_shift attribute, calculated from the photographing start time of the corresponding media data.

It should be noted that the time_shift attribute in the present embodiment, different from embodiment 1, indicates a deviation between the photographing start time of the media data and the time at which photographing of a target object was started by the photographing device 1 that captures the media data. Each video tag of this playback information also indicates that the media data corresponding to the video tag is to be played from a playback position corresponding to a value obtained by adding the value of the time_shift attribute to the value of the start_time attribute.

The playback control unit 38 may have a configuration in which the plurality of items of media data in question are sequentially played based on this playback information, and a video in which an object has been captured from directly behind (a video from the viewpoint of the object) is thereby presented to the viewing user.

### Example 2 of Playback Information

Furthermore, taking into consideration a case where there are no videos in which an object has been captured from directly behind, the playback information depicted in (b) of FIG. 22 may be used instead of the playback information depicted in (a) of FIG. 22. Specifically, similar to the aforementioned example 1 of the playback information, the playback control unit 38 refers to the resource information of specified media data, and specifies a position that has been shifted according to the position_shift attribute from the position of a specified object. In addition, the playback control unit 38 specifies, as a playback target, a video captured by the photographing device 1, which is an imaging device 1 in a position that is the most proximate to a position that has been shifted according to the position_shift attribute, in accordance with the “nearest” attribute value of the position_att attribute, and is facing the direction that is the nearest to the direction designated by the position_shift attribute. In the example depicted in (b) of FIG. 22, a video of an object that has been captured by the imaging device 1 that is the most proximate to directly behind the object can be presented to the viewing user.

It should be noted that there is a possibility that the position of the photographing device 1 that has captured media data selected according to “nearest” may have shifted considerably from a position designated by the user according to the position_ref attribute and the position_shift attribute. Therefore, when media data selected according to “nearest” is to be displayed, image processing such as zooming and panning may be carried out for it to be made difficult for the user to perceive the aforementioned shift.

### Example 3 of Playback Information

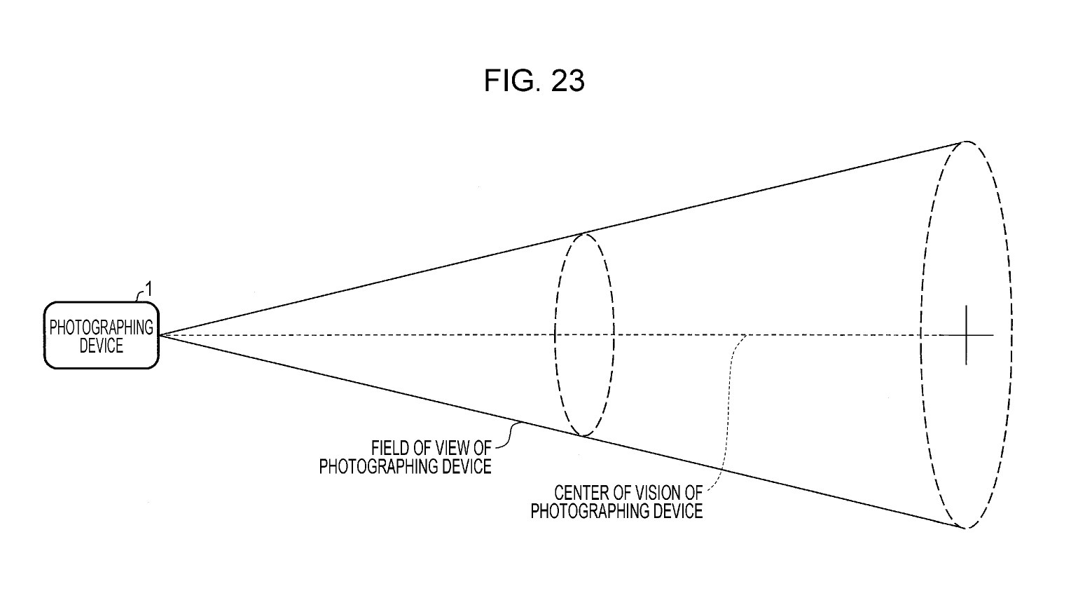

A playback mode for media data for which reference is made to another form of playback information will be described with reference to FIGS. 23 to 25.

This playback information is also used to allow the user to appreciate a video depicting the state of the view seen from an object (for example, a cat). FIG. 23 is a drawing depicting the field of view and center of vision of a photographing device 1 used to allow the user to appreciate this kind of video.

The field of view of the photographing device 1, as depicted in FIG. 23, can be defined as “a cone in which the photographing device 1 is the apex and the bottom face is infinitely distant”. In this case, the direction of the center of vision of the photographing device 1 matches the photographing direction of the photographing device 1. It should be noted that, since a video actually captured by the photographing device 1 is rectangular, the field of view of the photographing device 1 may be defined as “a quadrangular pyramid in which the photographing device 1 is the apex and the bottom face is infinitely distant”.

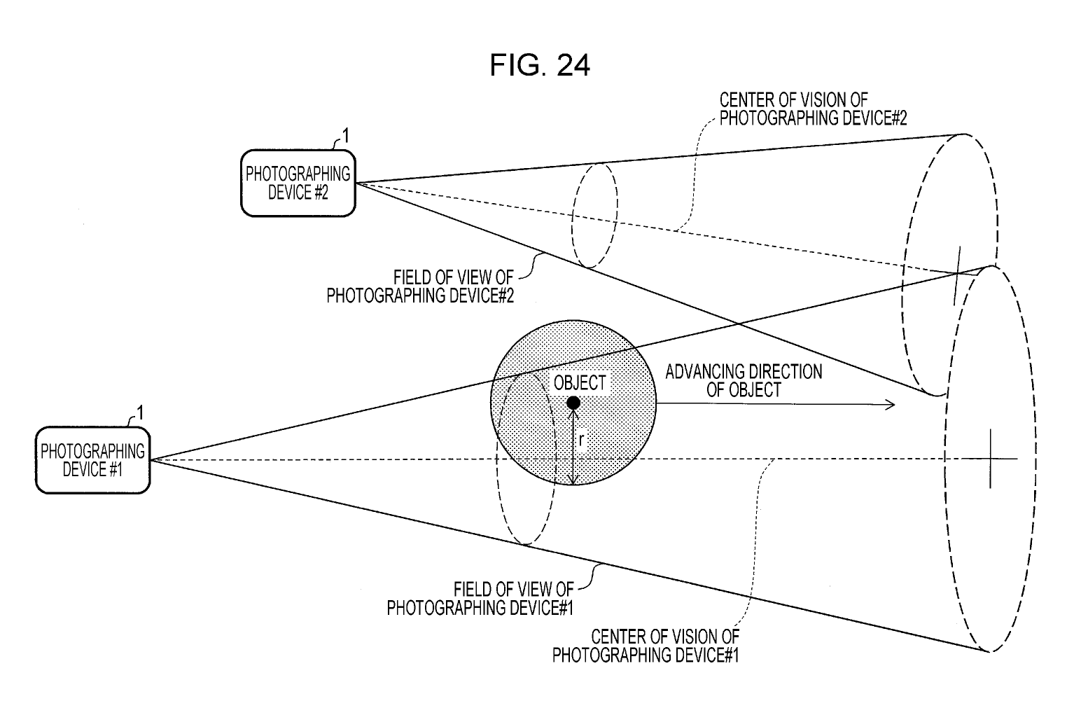

FIG. 24 is a drawing depicting the field of view and center of vision of the photographing devices 1 in FIG. 19. As depicted in FIG. 24, an object has entered the field of view cone of the #1 photographing device 1, and has not entered the field of view cone of the #2 photographing device 1. In other words, the object appears in a video captured by the #1 photographing device 1, and therefore this video cannot be used as it is as a video depicting the state of the view seen from the object.

Thus, with regard to each of one or more photographing devices 1 arranged to the rear of an object and facing a direction that is the same as the front direction of the object, the playback control unit 38 may determine whether or not the object has entered the field of view cones of the photographing devices 1, and may designate, as a playback target, a video captured by a photographing device 1 for which the object has not entered the field of view cone. It should be noted that the playback control unit 38 can carry out this determination by referring to the position and size of the object.

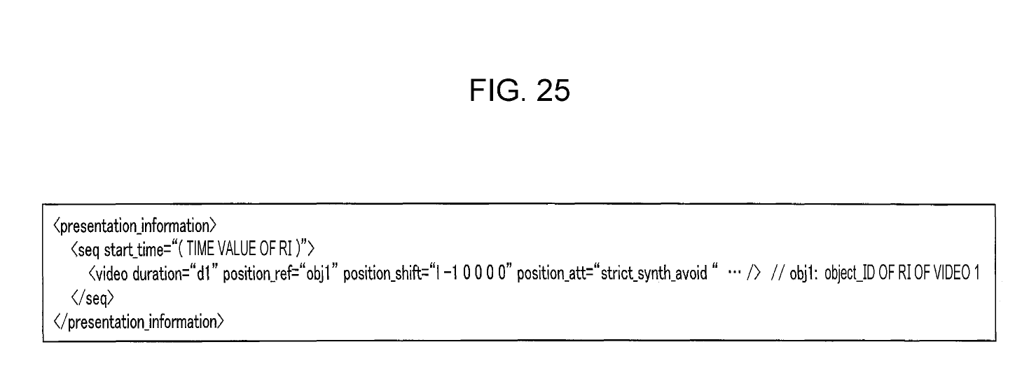

For example, the playback control unit 38 may use playback information such as that depicted in FIG. 25. FIG. 25 is a drawing depicting another example of playback information stipulating a playback mode for media data. The attribute value of the position_att attribute in the playback information depicted in FIG. 25 is “strict_synth_avoid”. This attribute value is an attribute value for designating, as a playback target, a video in which an object having the object ID (obj1) designated by the attribute value of “position_ref” does not appear. The number of videos designated by this attribute value may be one or may be a plurality.

In the case of the former, from among one or more imaging devices 1 that have captured a video in which the object does not appear, one video captured by the imaging device 1 that is nearest to the position designated by the attribute value of “position_ref” and the attribute value of “position_shift” becomes a playback target. Furthermore, in the case of the latter, a plurality of videos captured by a plurality of photographing devices 1 for which the distance from the position in question is within a predetermined range become playback targets.

Here, synthesis processing in a case where a plurality of videos have been designated will be described. The playback control unit 38 designates a plurality of items of media data in which the object does not appear and in which the state of the view from the object has been captured, generates a video of a designated playback target by synthesizing the plurality of items of designated media data, and plays the generated video.

Thus, a video which is seen from the rear side of the object and in which the object does not appear (in other words, a video in which the state of the view seen from the object is shown faithfully to a certain extent) can be presented to the viewing user.

It should be noted that the playback control unit 38 may carry out the processing hereinafter instead of the aforementioned processing.

In other words, the playback control unit 38 may generate a video of a designated playback target by extracting partial videos in which the object does not appear, from a plurality of items of media data in which the object does appear, captured by an imaging device 1 arranged to the rear of the object, and synthesizing the extracted partial videos. Furthermore, in a case where playback-target media data is a video image, and when an object (cat) appears in a frame at a playback-target time, the playback control unit 38, by calculating the difference between the frame and a past frame in which the object does not appear, may generate a frame in which the object does not appear, and play the generated frame.

Furthermore, in the media-related information generation system 101 in the present embodiment, when mapping media data, scaling may be carried out with reference being made to the size information (object_occupancy) of an object. For example, the average size of a person may serve as a reference value, a comparison may be carried out between the reference value and the size of an object indicated by the size information of the object, and mapping may be carried out according to the result of the comparison in question. For example, in a case where the object is a cat and the size of the object indicated by the size information of the object was 1/10 of the reference value, a 1×1×1 imaging system may be mapped to a 10×10×10 display system. Furthermore, image processing such as zooming may be carried out, and a 10× zoom video may be displayed. In this way, in the media-related information generation system 101, a video having a small scale is displayed in a case where the object is large, and a video having a large scale is displayed in a case where the object is small, and a video from the viewpoint of the object having a greater sense of reality can thereby be presented to the viewing user.

Furthermore, in the media-related information generation system 101 in the present embodiment, a configuration may be implemented in which advancing speed information that indicates the speed at which an object is advancing is included in resource information. In the case of an object having a fast advancing speed such as a ball in a ball game or an F1 car, for example, a video from the viewpoint of the object is too fast, and therefore a video from the viewpoint of the object having a sense of reality cannot be presented to the viewing user. Thus, by using the aforementioned configuration, the playback control unit 38 is able to carry out scaling (slow playback) for an appropriate playback speed by referring to the advancing speed information in question.

### (Example 1 Using Media-Related Information Generation System 101)

By using this kind of playback information, for example, a street view from the viewpoint of a cat can be presented to the viewing user. More specifically, the server 2 acquires media data of videos in which a cat and the periphery thereof are captured by a camera of a user (a smartphone or the like) and a camera of a service provider (a 360-degree camera, an unmanned aircraft mounted with a camera, or the like). The server 2 calculates the position, size, and front direction (the direction of the face or the advancing direction) of the cat in the acquired videos, and generates resource information.

Next, the server 2 uses an aforementioned attribute value (for example, the “strict_synth_avoid” attribute value of the position_att attribute), to generate playback information for specifying a video that is a video in which the cat does not appear, and has been captured by a camera to the rear of the cat, and distributes the playback information in question to the playback device 3. Here, the server 2 may have a configuration in which a video is enlarged or reduced according to the size of the cat, and the playback speed is changed according to the movement speed of the cat. The playback device 3, by carrying out playback using the acquired playback information, is able to present a street view from the viewpoint of a cat (a viewpoint that is lower than that of a person and is an unexpected angle) to the viewing user. Furthermore, a street view from the viewpoint of a child can also be presented to the viewing user by using a similar method.

In addition, the server 2 may specify a plurality of items of media data in which a cat has been captured from the rear, and generate playback information in which a plurality of video tags corresponding to the plurality of items of media data in question are arranged side-by-side in order of the time at which photographing of the cat from the rear was started. Each video tag of this playback information includes the photographing start time of the corresponding media data as the value of the start_time attribute, and includes the value of the time_shift attribute, calculated from the photographing start time of the corresponding media data. It should be noted that, similar to the aforementioned configuration, the time_shift attribute in the present embodiment indicates a deviation between the photographing start_time of the media data and the time at which photographing of the cat was started by the photographing device that captures the media data. Also, each video tag of this playback information indicates that the media data corresponding to the video tag is to be played from a playback position corresponding to a value obtained by adding the value of the time_shift attribute to the value of the start_time attribute. According to this configuration, the playback device 3, by causing a plurality of items of media data to be sequentially played based on this playback information, is able to present the user with a street view in which a cat is tracked.

### (Example 2 Using Media-Related Information Generation System 101)

Furthermore, by using this kind of playback information, for example, a video from the viewpoint of a ball in a ball game can be presented to the viewing user. More specifically, the server 2 acquires media data of videos in which a ball during a match and the periphery thereof are captured by a plurality of cameras installed in a stadium. The server 2 calculates the position, size, front (the advancing direction), and advancing speed of the ball in the acquired videos, and generates resource information.

Next, the server 2 uses an aforementioned attribute value (for example, the “strict_synth_avoid” attribute value of the position_att attribute), to generate playback information for specifying a video that is a video in which the ball does not appear, and has been captured by a camera to the rear of the moving ball, and distributes the playback information in question to the playback device 3. Here, the server 2 may have a configuration in which a video is enlarged or reduced according to the size of the ball, and the playback speed is changed according to the movement speed of the ball. Furthermore, in the case of a fast object that exceeds 200 kilometers per hour such as a tennis ball, for example, the playback speed may be further slowed down. The playback device 3, by carrying out playback using the acquired playback information, is able to present a video from the viewpoint of a ball to the viewing user. Furthermore, by using a similar method, the user can be presented with a video from the viewpoint of a racehorse or the viewpoint of a jockey in a horse race, or from the viewpoint of a bird by using videos captured by an unmanned aircraft mounted with a camera.

In addition, the server 2 may specify a plurality of items of media data in which a moving ball has been captured from the rear, and generate playback information in which a plurality of video tags corresponding to the plurality of items of media data in question are arranged side-by-side in order of the time at which photographing of the moving ball from the rear was started. Each video tag of this playback information includes the photographing start_time of the corresponding media data as the value of start_time, and includes the value of the time_shift attribute, calculated from the photographing start_time of the corresponding media data. It should be noted that, similar to the aforementioned configuration, the time_shift attribute in the present embodiment indicates a deviation between the photographing start time of the media data and the time at which photographing of the moving ball was started by the photographing device that captures the media data. Also, each video tag of this playback information indicates that the media data corresponding to the video tag is to be played from a playback position corresponding to a value obtained by adding the value of the time_shift attribute to the value of the start_time attribute. According to this configuration, the playback device 3, by causing a plurality of items of media data to be sequentially played based on this playback information, is able to present the user with a video in which a ball is tracked.

In this way, in the media-related information generation system 101 according to the present embodiment, the front direction of an object indicated by direction information included in resource information is taken as the direction in which a face is directed in a case where the object has a face, and is taken as the advancing direction of the object in a case where the object does not have a face, and, by referring to the direction information in question and the position information of the object, a video from the viewpoint of the object can be presented to the user. Furthermore, in the media-related information generation system 101, as a result of object size information indicating the size of an object being additionally included in resource information, a video from the viewpoint of the object can be presented to the user as a video having a greater sense of reality. In other words, in the media-related information generation system 101, it is possible to present a video from an unexpected viewpoint that the user is ordinarily not able to see.

### Modified Examples

In the aforementioned embodiments, examples have been given in which resource information is generated by the photographing device 1 alone or by the photographing device 1 and the server 2; however, the server 2 alone may generate resource information. In this case, the photographing device 1 transmits media data obtained by photographing to the server 2, and the server 2 analyzes the received media data to thereby generate resource information.

Furthermore, the processing for generating resource information may be carried out by a plurality of servers. For example, resource information that is similar to that of the aforementioned embodiments can be generated even with a system including a server that acquires various types of information (such as the position information of an object) included in resource information, and a server that generates resource information using the various types of information acquired by the aforementioned server.

### [Example of Implementation by Software]

Control blocks for the photographing device 1, the server 2, and the playback device 3 (in particular, the control unit 10, the server control unit 20, and the playback device control unit 30) may be realized by logic circuits (hardware) formed in an integrated circuit (IC chip) or the like, or may be realized by software using a CPU (central processing unit).

In the case of the latter, the photographing device 1, the server 2, and the playback device 3 are provided with, for example: a CPU that executes instructions of a program that is software for realizing each function; a ROM (read only memory) or a storage device (these are referred to as a “recording medium”) in which the program and various types of data are recorded in a computer (or CPU) readable manner; and a RAM (random access memory) that deploys the program. The objective of the present invention is then achieved by the computer (or the CPU) reading the program from the recording medium and executing the program. As the recording medium, it is possible to use a “non-transitory tangible media”; for example, tape, a disk, a card, a semiconductor memory, a programmable logic circuit, or the like. Furthermore, the program may be provided to the computer via an arbitrary transmission medium (a communication network, broadcast waves, or the like) that is capable of transmitting the program. It should be noted that the present invention can also be realized in the form of a data signal that is embedded in carrier waves, in which the program is realized by electronic transmission.

### CONCLUSION

A generation device (photographing device 1/server 2) according to aspect 1 of the present invention is a generation device of description information relating to data of a video, and is provided with: a target information acquisition unit (target information acquisition unit 17/data acquisition unit 25) that acquires position information indicating a position of a predetermined object within the video; and a description information generation unit (resource information generation unit 18/26) that generates description information (resource information) including the position information, as the description information relating to the data of the video.

According to the aforementioned configuration, position information indicating the position of a predetermined object in a video is acquired, and description information including the position information is generated. By referring to this kind of description information, it is possible to specify that the predetermined object is included in a photographic subject of that video, and it is also possible to specify the position thereof. Consequently, it also becomes possible to extract a video that captures an object that is located near to the position of a certain object, for example, specify a period in which an object is present in a certain position, and the like. It then also becomes possible to thereby play videos in a playback mode that could not be easily carried out in the past, and to manage videos according to new standards that did not exist in the past. In other words, according to the aforementioned configuration, it is possible to generate new description information that can be used for the playback, management, and the like of video data.

For a generation device according to aspect 2 of the present invention, in the aforementioned aspect 1, the target information acquisition unit may acquire direction information indicating a direction of the object, and the description information generation unit may generate description information including the position information and the direction information, as description information corresponding to the video.

According to the aforementioned configuration, direction information indicating the direction of the object is acquired, and description information including the position information and the direction information is generated. It thereby becomes easy for a video to be managed and played based on the direction of the object. For example, it becomes easy to extract a video in which the object has been captured in a desired direction from among a plurality of videos. Furthermore, for example, causing a video to be displayed by a display device that corresponds to the direction of the object, causing a video to be displayed in a position that corresponds to the direction of the object on a display screen, or the like can also be easily carried out.

For a generation device according to aspect 3 of the present invention, in the aforementioned aspect 1 or 2, the target information acquisition unit may acquire relative position information indicating a relative position of a photographing device that captured the video with respect to the object, and the description information generation unit may generate description information including the position information and the relative position information, as the description information corresponding to the video.

According to the aforementioned configuration, relative position information indicating the relative position of the photographing device with respect to the object is acquired, and description information including the position information and the relative position information is generated. It thereby becomes easy for a video to be managed and played based on the position of the photographing device (the photographing position). For example, extracting a video that has been captured near the object, and causing a video to be displayed by a display device in a position that corresponds to the distance between the object and the photographing position can also be easily carried out.

For a generation device according to aspect 4 of the present invention, in any of the aforementioned aspects 1 to 3, the target information acquisition unit may acquire size information indicating a size of the object, and the description information generation unit may generate description information including the position information and the size information, as the description information corresponding to the video.

According to the aforementioned configuration, size information indicating the size of the object is acquired, and description information including the position information and the size information is generated. Thus, a video which is seen from the rear side of the object and in which the object does not appear (in other words, a video in which the state of the view seen from the object is shown faithfully to a certain extent) can be presented to the viewing user. Furthermore, a video having a small scale is displayed in a case where the object is large, and a video having a large scale is displayed in a case where the object is small, and a video from the viewpoint of the object having a greater sense of reality can thereby be presented to the viewing user.

A generation device (photographing device 1/server 2) according to aspect 5 of the present invention is a generation device of description information relating to data of a video, provided with: a target information acquisition unit (target information acquisition unit 17/data acquisition unit 25) that acquires position information indicating a position of a predetermined object within the video; a photographing information acquisition unit (photographing information acquisition unit 16/data acquisition unit 25) that acquires position information indicating a position of a photographing device that captured the video; and a description information generation unit (resource information generation unit 18/26) that generates, as the description information relating to the data of the video, description information that includes information (position_flag) indicating which position information is included out of the position information acquired by the target information acquisition unit and the position information acquired by the photographing information acquisition unit, and also includes the position information indicated by the information.

According to the aforementioned configuration, description information is generated which includes information indicating which position information is included out of the position information of the object acquired by the target information acquisition unit, and the position information of the photographing device (position information indicating the photographing position) acquired by the photographing information acquisition unit, and also includes the position information indicated by the information. That is, according to the aforementioned configuration, it is possible to generate description information including position information regarding the photographing position, and it is also possible to generate description information including position information regarding the object position. By using these items of position information, it also becomes possible to play a video in a playback mode that could not be easily carried out in the past, and to manage a video according to a new standard that did not exist in the past. In other words, according to the aforementioned configuration, it is possible to generate new description information that can be used for the playback, management, and the like of video data.

A generation device (photographing device 1) according to aspect 6 of the present invention is a generation device of description information relating to data of a video image, provided with: an information acquisition unit (photographing information acquisition unit 16/target information acquisition unit 17) that respectively acquires position information indicating a photographing position of the video image or a position of a predetermined object within the video image, at a plurality of different points in time from capturing of the video image starting to ending; and a description information generation unit (resource information generation unit 18) that generates description information including the position information at the plurality of different points in time, as the description information relating to the data of the video image.

According to the aforementioned configuration, items of position information indicating a photographing position of a video image or a position of a predetermined object within the video image, at a plurality of different points in time from capturing of the video image starting to ending, are respectively acquired, and description information including these items of position information is generated. By referring to this description information, it becomes possible to track transitions in the photographing position and the object position in a period in which the video image is captured. It then also becomes possible to thereby play videos in a playback mode that could not be easily carried out in the past, and to manage videos according to new standards that did not exist in the past. In other words, according to the aforementioned configuration, it is possible to generate new description information that can be used for the playback, management, and the like of video data.

The generation device according to each aspect of the present invention may be realized by a computer, and, in this case, a control program for the generation device that causes the computer to realize the generation device by causing the computer to operate as the units (software elements) provided in the generation device, and a computer-readable recording medium having the control program recorded thereon are also within the category of the present invention.

The present invention is not restricted to the aforementioned embodiments, various alterations are possible within the scope indicated in the claims, and embodiments obtained by appropriately combining the technical means disclosed in each of the different embodiments are also included within the technical scope of the present invention. In addition, novel technical features can be formed by combining the technical means disclosed in each of the embodiments.

### INDUSTRIAL APPLICABILITY

The present invention can be used in a device that generates description information that describes information relating to a video, a device that plays a video using the description information, or the like.

### REFERENCE SIGNS LIST

1 Photographing device (generation device)
16 Photographing information acquisition unit (information acquisition unit)
17 Target information acquisition unit (information acquisition unit)
18 Resource information generation unit (description information generation unit)
2 Server (generation device)
25 Data acquisition unit (information acquisition unit, photographing information acquisition unit, target information acquisition unit)
26 Resource information generation unit (description information generation unit)

1. A generation device of description information relating to data of a video, comprising:
a target information acquisition unit that acquires position information indicating a position of a predetermined object within the video; and
a description information generation unit that generates description information including the position information, as the description information relating to the data of the video.

2. The generation device according to claim 1, wherein
the target information acquisition unit acquires direction information indicating a direction of the object, and
the description information generation unit generates description information including the position information and the direction information, as description information corresponding to the video.

3. The generation device according to claim 1, wherein
the target information acquisition unit acquires relative position information indicating a relative position of a photographing device that captured the video with respect to the object, and
the description information generation unit generates description information including the position information and the relative position information, as the description information corresponding to the video.

4. The generation device according to claim 1, wherein
the target information acquisition unit acquires size information indicating a size of the object, and
the description information generation unit generates description information including the position information and the size information, as the description information corresponding to the video.

5. A generation device of description information relating to data of a video, comprising:
a target information acquisition unit that acquires position information indicating a position of a predetermined object within the video;
a photographing information acquisition unit that acquires position information indicating a position of a photographing device that captured the video; and
a description information generation unit that generates, as the description information relating to the data of the video, description information that includes information indicating which position information is included out of the position information acquired by the target information acquisition unit and the position information acquired by the photographing information acquisition unit, and also includes the position information indicated by the information.

6. A generation device of description information relating to data of a video image, comprising:
an information acquisition unit that respectively acquires position information indicating a photographing position of the video image or a position of a predetermined object within the video image, at a plurality of different points in time from capturing of the video image starting to ending; and
a description information generation unit that generates description information including the position information at the plurality of different points in time, as the description information relating to the data of the video image.
